(19) United States
(12) Patent Application Publication
(10) Pub. No.: US 2013/0007088 A1
(43) Pub. Date: Jan. 3, 2013

(54) METHOD AND APPARATUS FOR COMPUTATIONAL FLOW EXECUTION

(75) Inventors: D'Elia Alfredo, Catanzaro (IT); Jukka Honkola, Espoo (FI); Vesa-Veikko Luukkala, Espoo (FI); Sergey Boldyrev, Soderkulla (FI)

(73) Assignee: Nokia Corporation, Espoo (FI)

(21) Appl. No.: 13/171,065

(22) Filed: Jun. 28, 2011

(51) Int. Cl. G06F 15/16

(52) U.S. Cl. 709/201

(57) ABSTRACT

An approach is provided for optimizing computational flow execution. A computational flow execution platform determines to cause, at least in part, a construction of at least one computational flow from one or more functional blocks, wherein the one or more functional blocks include, at least in part, one or more computational closures, one or more other functional blocks, or a combination thereof. The computational flow execution platform also processes and/or facilitates a processing of the at least one computational flow, the one or more functional blocks, or a combination thereof to cause a distribution of the one or more functional blocks among one or more entities of a computational environment. The computational flow execution platform further causes, at least in part, an execution of the at least one computational flow, the one or more functional blocks, or a combination thereof based, at least in part, on the distribution.

### BACKGROUND

Mobile devices are becoming the primary gateway to the internet for many people. Combining functionalities and data of mobile devices with personal computers, sensor devices, internet service platforms, etc. is a major challenge of interoperability. This can be achieved through numerous, individual and personal information spaces in which entities (e.g., service providers, network operators, publishers, application developers, end users, etc.) can place, share, interact and manipulate (or program devices to automatically perform the planning, interaction and manipulation of) webs of information with their own locally agreed semantics without necessarily conforming to an unobtainable, global whole. In addition to information, the information spaces may be combined with webs of shared and interactive computations or computation spaces so that the devices having connectivity to the computation spaces can have the information in the information space manipulated within the computation space environment and the results delivered to the device, rather than the whole process being performed locally in the device.

It is noted that such computation spaces may consist of connectivity between devices, from devices to network infrastructure, to distributed information spaces so that computations can be executed where enough computational elements are available. These combined information spaces and computation spaces often referred to as computation clouds, are extensions of the ‘Giant Global Graph’ in which one can apply semantics and reasoning at a local level.

In one example, clouds are working spaces respectively embedded with distributed information and computation infrastructures spanned around computers, information appliances, processing devices and sensors that allow people to work efficiently through access to information and computations from computers or other devices. An information space or a computation space can be rendered by the computation devices physically presented as heterogeneous networks (wired and wireless). However, despite the fact that information and computation presented by the respective spaces can be distributed with different granularity, still there are challenges in certain example implementations to achieve scalable high context information processing within such heterogeneous environments. For example, in various implementations, due to distributed nature of the cloud, exchange of data, information, and computation elements (e.g., computational closures) among distributed devices involved in a cloud infrastructure may require excessive amount of resources (e.g. Process time, process power, storage space, etc.). In various example circumstances, to enhance the information processing power of a device and reduce the processing cost, one might consider minimizing or at least significantly improving exchange of data, information and computations among the distributed devices.

As more resources become available over the Internet, an increasing number of the entities are distributing workloads to various resources over the Internet. There are some approaches proposed to improve data distribution within a computational environment, such as providing multi-level distributed computations to migrate data to the most cost effective computation level with minimum cost. Various factors, such as computation capabilities, resource availability, and resource cost at every computation environment, need to be considered during workload distribution, to determine cost effective strategies. However, it is inefficient to distribute workload of a computational flow based upon a computational closure as a basic unit.

### SOME EXAMPLE EMBODIMENTS

Therefore, there is a need for an approach for optimizing computational flow execution.

According to one embodiment, a method comprises determining to cause, at least in part, a construction of at least one computational flow from one or more functional blocks, wherein the one or more functional blocks include, at least in part, one or more computational closures, one or more other functional blocks, or a combination thereof. The method also comprises processing and/or facilitating a processing of the at least one computational flow, the one or more functional blocks, or a combination thereof to cause, at least in part, a distribution of the one or more functional blocks among one or more entities of a computational environment. The method further comprises causing, at least in part, an execution of the at least one computational flow, the one or more functional blocks, or a combination thereof based, at least in part, on the distribution.

According to another embodiment, an apparatus comprises at least one processor, and at least one memory including computer program code, the at least one memory and the computer program code configured to, with the at least one processor, cause, at least in part, the apparatus to determine to cause, at least in part, a construction of at least one computational flow from one or more functional blocks, wherein the one or more functional blocks include, at least in part, one or more computational closures, one or more other functional blocks, or a combination thereof. The apparatus is also caused to process and/or facilitate a processing of the at least one computational flow, the one or more functional blocks, or a combination thereof to cause, at least in part, a distribution of the one or more functional blocks among one or more entities of a computational environment. The apparatus is further caused to cause, at least in part, an execution of the at least one computational flow, the one or more functional blocks, or a combination thereof based, at least in part, on the distribution.

According to another embodiment, a computer-readable storage medium carries one or more sequences of one or more instructions which, when executed by one or more processors, cause, at least in part, an apparatus to determine to cause, at least in part, a construction of at least one computational flow from one or more functional blocks, wherein the one or more functional blocks include, at least in part, one or more computational closures, one or more other functional blocks, or a combination thereof. The apparatus is also caused to process and/or facilitate a processing of the at least one computational flow, the one or more functional blocks, or a combination thereof to cause, at least in part, a distribution of the one or more functional blocks among one or more entities of a computational environment. The apparatus is further caused to cause, at least in part, an execution of the at least one computational flow, the one or more functional blocks, or a combination thereof based, at least in part, on the distribution.

According to another embodiment, an apparatus comprises means for determining to cause, at least in part, a construction of at least one computational flow from one or more functional blocks, wherein the one or more functional blocks include, at least in part, one or more computational closures, one or more other functional blocks, or a combination thereof. The apparatus also comprises means for processing and/or facilitating a processing of the at least one computational flow, the one or more functional blocks, or a combination thereof to cause, at least in part, a distribution of the one or more functional blocks among one or more entities of a computational environment. The apparatus further comprises means for causing, at least in part, an execution of the at least one computational flow, the one or more functional blocks, or a combination thereof based, at least in part, on the distribution.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (including derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing computational flow execution, according to one embodiment;

FIG. 2 is a diagram of the components of a computational flow execution platform, according to one embodiment;

FIG. 3 is a flowchart of a process for providing computational flow execution with functional blocks, according to one embodiment;

FIG. 4 is a representation of computation distribution and computational flow execution, according to one embodiment;

FIG. 5 is a diagram of cost estimation when various capabilities are involved, according to one embodiment;

FIG. 6 is a diagram of parallel computation of a computational flow, according to one embodiment.

FIGS. 7A-7B are diagrams of computation distribution among devices, according to one embodiment;

FIG. 8 is a diagram of computational flow distribution from a device to a backend environment, according to one embodiment;

FIG. 9 is a diagram of computational allocation/mapping, according to one embodiment;

FIG. 10 is a diagram of hardware that can be used to implement an embodiment of the invention;

FIG. 11 is a diagram of a chip set that can be used to implement an embodiment of the invention; and

FIG. 12 is a diagram of a mobile terminal (e.g., handset) that can be used to implement an embodiment of the invention.

### DESCRIPTION OF SOME EMBODIMENTS

Examples of a method, apparatus, and computer program for providing computational flow execution are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein, the term “computational closure” identifies a particular computation procedure together with relations and communications among various processes including passing arguments, sharing process results, selecting results provided from computation of alternative inputs, flow of data and process results, etc. The computational closures (e.g., a granular reflective set of instructions, data, and/or related execution context or state) provide the capability of slicing of computations for processes and transmitting the computation slices between devices, infrastructures and information sources.

As used herein, the term “cloud” refers to an aggregated set of information and computational closures from different sources. This multi-sourcing is very flexible since it accounts and relies on the observation that the same piece of information or computation can come from different sources. In one embodiment, information and computations within the cloud are represented using Semantic Web standards such as Resource Description Framework (RDF), RDF Schema (RDFS), OWL (Web Ontology Language), FOAF (Friend of a Friend ontology), rule sets in RuleML (Rule Markup Language), etc. Furthermore, as used herein, RDF refers to a family of World Wide Web Consortium (W3C) specifications originally designed as a metadata data model. It has come to be used as a general method for conceptual description or modeling of information and computations that is implemented in web resources; using a variety of syntax formats. Although various embodiments are described with respect to clouds, it is contemplated that the approach described herein may be used with other structures and conceptual description methods used to create distributed models of information and computations.

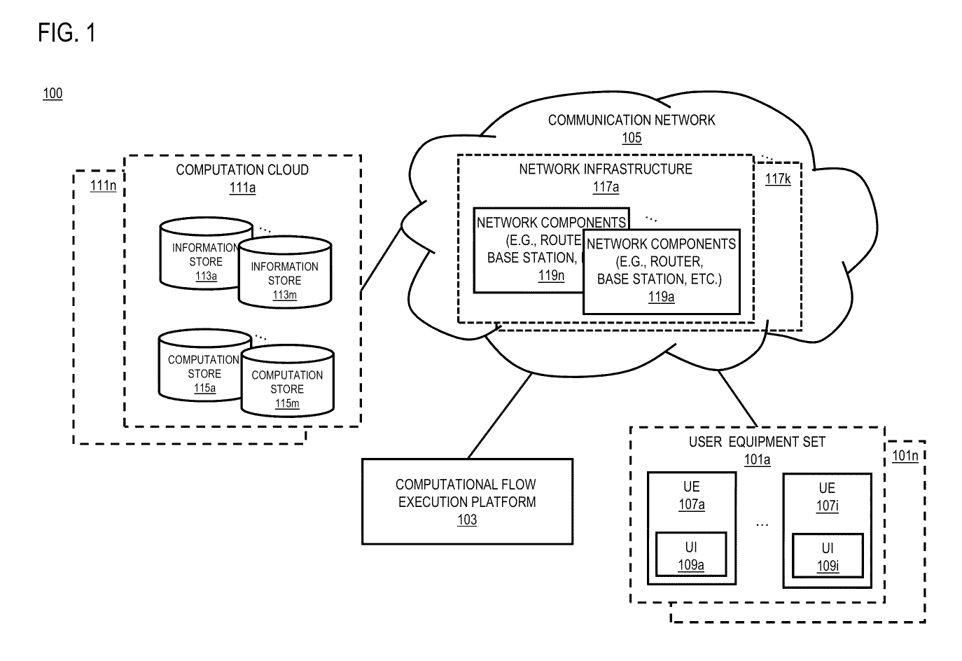

FIG. 1 is a diagram of a system capable of providing computational flow execution, according to one embodiment. As previously described, a cloud environment consists of information and computation resources each consisting of several distributed devices that communicate information and computational closures (e.g., in RDF graphs) via a shared memory. A device within a cloud environment may store computational closures locally in its own memory space or publish computational closures on a globally accessible environment within the cloud. In the first case, the device is responsible for any process needed for combination or extraction of computations, while in the second case the processes can be conducted by the globally accessible environment which includes the device. The device can utilize the resources of the architectural infrastructure level, for example for energy saving, without having to access the cloud level, if energy cost is lower at infrastructure level. Alternatively, a device may have direct computational closure connectors to cloud level, where devices are more tightly linked to cloud environment for energy saving purposes.

The basic concept of cloud computing technology provides access to distributed computations for various resources (that may reside in one or more devices, routers, servers, apparatus, etc.) within the scope of the cloud, in such a way that the distributed nature of the computations is hidden from users/entities and it appears to a user as if all the computations are performed on the same resource. The cloud computing also enables a user to have control over computation distribution by transferring computations between resources that the user has access to. For example, a user may want to transfer computations among work devices, home devices, and portable devices, other private and public devices, etc. Current technologies enable a user to manipulate contexts such as data and information via the elements of a user interface of their user equipment. However, distribution of computations and processes related to or acting on the data and information within the cloud is typically controlled by a system. In other words, a cloud in general does not provide a user/entity (e.g., an owner of a collection of information distributed over the information space) with the ability to control distribution of related computations and processes of, for instance, applications acting on the information.

For example, a contact management application that processes contact information distributed within one or more clouds generally executes on a single device (e.g., with all processes and computations of the application also executing on the same device) to operate on the distributed information. In some cases (e.g., when computations are complex, the data set is large, etc.), providing a means to also distribute the related computations in addition to the information is advantageous.

This can be achieved by introduction of the capability to construct, distribute, and aggregate computations as well as their related data. In one embodiment, a computational environment consists of a plurality of architectural levels, including a device level, and infrastructure level, and a cloud computing level. A device from the device level has connectivity to the cloud computing level via one or more infrastructure levels, wherein each infrastructure level may consist of layers and components such as backbones, routers, base stations, etc. The components of the infrastructure levels may be equipped with various resources (e.g., processing environments, storage spaces, etc.) that can be utilized for the execution of computational closures associated with a process. Since the infrastructure level functions as an interface between the device level and the cloud computing level, if the computational closures can be executed in the infrastructure level, there will be no need for the computational closures to be migrated to the cloud computing level that may very well require excessive use of resources.

More specifically, to enable a user of a cloud (e.g., a mobile device user, an application developer, etc.) who connects to the cloud via one or more devices, to distribute computations among the one or more user devices or other devices with access to the cloud, each computation is deconstructed to its basic or primitive processes or computational closures. Once the computation of a computational flow is divided into its primitive computational closures, the processes within or represented by each closure may be executed in a distributed fashion and the processing results can be collected and aggregated into the result of the execution of the initial overall computation. Typically, the computational closures associated with a computational flow are defined, constructed, and executed within the device computing level, the infrastructure level, the cloud level, or a combination thereof. Therefore, execution of computational closures associated with a process related to a device at the infrastructure level can provide services to device users in an efficient manner.

However, there are sets of computational closures that are repeatedly grouped and assembled to perform popular functions. Since resources within the multi-level architectural environment of device level, infrastructure level and cloud level each may differ in configuration, availability, processing power, storage volume, communication capability, energy level, etc., there is a need to call out the sets of computational closures without repeating recomposing a set of computational closures.

Furthermore, execution of computational closures may require various kinds and levels of resources depending on, for example, the computation complexity of the closures. It is inefficient to distribute workload of a computational flow based upon a computational closure as a basic unit, due to this diversity, considering resource related factors such as availability of computation environments and consumption of computations in distribution of workload across components of an architectural level. There is a need to updating changes of computational closures in the respective sets without repeating surveying each computational closure in each set.

To address these problems, a system 100 of FIG. 1 introduces the capability of providing and utilizing functional blocks for executing a computational flow. Each functional block includes, at least in part, one or more computational closures, one or more other functional blocks, or a combination thereof. Each functional block is created in consideration of computational efficiencies within various levels of granularity and various structures among various independent sources. Once a functional block is created, it is stored for reuse. By constructing of a computational flow from one or more functional blocks, a user/entity saves the effort of recreating functional blocks, thereby improving computation efficiency within a heterogeneous computational environment of multi-level architectures. The system 100 also handles computations in order to maximize parallelism, minimize delay, or a combination thereof. The system 100 can use an ontology (e.g., OWL) to describe units of computations and their connections in a data structure (e.g., RDF). The system 100 serializes and recomposes computations made up of several connected blocks in order to distribute the calculations in an entity, an information store, an information space, a cloud, or a combination thereof.

The system 100 operates in a multi-language multiplatform framework for execution optimization according to cost functions. A large set of basic functionalities can be created and added to the system 100 as elementary executable blocks (e.g., a functional block). When a new block is constructed and added to the system 100 it can be used and reused in programs as a building block.

By way of example, the computational environment includes different levels of proactive computational elements available for various levels thereof, such as a device level, an infrastructure level, and a cloud computing level. The computational elements provide various levels of functionality for each of the levels, and distribution of computational closures within the computational environment enables the execution of the computational flow, the one or more functional blocks, or a combination thereof.

In one embodiment, a functional block contains only one computational closure. In another embodiment, a functional block contains a plurality of computational closures. In one embodiment, a functional block contains computational closures of only one level of the computational environment such as a device level, ac infrastructure level, and ca loud computing level. In other embodiments, a functional block contains computational closures of two or more levels of the computational environment.

In one embodiment, the system 100 determines and compares resource consumption of computational closures between devices and infrastructures and between infrastructures and clouds, to provide a functional block. The system 100 determines where it is more cost effective to transfer computational closures to, what the resource operational range for each computational closure is (taking into account other capabilities relevant for the computation such as security, privacy levels and rules, other issues like battery vs. Main power plug connection, etc.), what the minimum and the maximum threshold values for remote/local computations are, etc.

The approach for optimizing execution of the computational flow is to utilize existing functional blocks for distributing workload. In one embodiment, the system 100 detects, identifies, and updates resource availability and cost per function block, including what types and levels of resource capabilities and availabilities exist at each computational closure within the multi-level computational levels of the functional block, and what is the efficient distribution of closures within each functional block, considering cost functions. Once a functional block is updated due to any changes of its components, it can be published in the cloud to be utilized in different computational flows. For those computational flows which already include the functional block, their corresponding functional blocks can be updated via a subscription mechanism for the changes to the functional block, or for the whole updated functional block. Therefore, the functional block and any computational flow utilizing the functional block can be updated efficiently.

In one embodiment, such a change causes the system 100 to transfer certain amount of computation functionality from device level to infrastructure level or further to cloud level depending on the available capabilities at each level. By way of example, for computations associated with a battery operated laptop computer, it is more beneficial if parts of the computations are performed at infrastructure level (e.g., a router). However, when the mobile device is plugged into a power socket with an energy cost lower than the energy cost of the infrastructure resource, the system 101 updates one or more functional blocks, thus distributes the workload back to the mobile device.

In one embodiment, the system 100 determines ontology associated with a computational flow of interest and functional blocks, constructs the computational flow from one or more of the functional blocks with connectors, functions, interfaces, etc. in-between. The ontology determines semantic descriptions of the connectors, the functions, and the interfaces. The system 100 then distributes the functional blocks among one or more entities of a computational environment based on the ontology, and causes resources to execute the functional blocks based on the distribution. The distribution and the execution are based on the semantic descriptions. In another embodiment, at least one of the distribution and the execution are processed in parallel to further improve computational efficiency.

In one embodiment, the system 100 determines one or more cost functions associated with the computational flow, the one or more functional blocks, or a combination thereof. The one or more cost functions relate to one or more resources, one or privacy policies, one or more security policies, or a combination associated with the entities. At least one of the execution and the distribution are based, at least in part, on the one or more cost functions.

By way of example, a cost function of a device setup at various architectural levels may includes factor such as battery consumption, quality of service (QOS) settings, class of service (COS) settings, priority settings etc. The cost factors may affect direction and method of computational distribution, as different setups may lead to different situations of resource availability and requirement. Additionally, cost can be indirectly affected by other features of architectural levels such as resource consumption strategies, privacy settings, security enforcements, etc. Cost optimization of the computational flow, the one or more functional blocks, or a combination thereof, can be achieved by different architectures of computation distribution. The system 100 utilizes as many functional blocks as possible, to spare the time to recalculate the cost functions for the computational closures of each functional block.

In one embodiment, when an infrastructure node has a limited resource, the computations may be transferred to a next nearest node with available resource where computation can continue, and redistributed to the cloud level if there is no infrastructure node with sufficient resource available. It is noted that different device setups, limits and thresholds may change computational distribution thus change all associated functional blocks and computational flows. Resource availability can be different, for example, depending on the instant battery, energy or power down cost, etc.

Furthermore, cost can be different and can be indirectly affected by other features of device, infrastructure, or cloud level, such as load balancing, privacy, security enforcements, etc. In one embodiment, the cost functions may determine to what extent operational, energy, security, privacy and other capabilities can be taken into account. Alternatively, cost functions may exceed or get cut beyond thresholds.

In one embodiment, the system 100 represents the computational flow, the one or more functional blocks, or a combination thereof, in at least one data structure (e.g., a resource description framework, RDF) of at least one information space, at least one information store, at least one cloud computing component, or a combination thereof. The system 100 associates the one or more costs functions with the at least one data structure. In another embodiment, the system 100 causes, at least in part, publication of the at least one data structure and/or subscription to a change of the at least one data structure, with the at least one information space, the at least one information store, the at least one cloud computing component, or a combination thereof.

In another embodiment, when the at least one data structure is based, at least in part, on a RDF graph, the system 100 causes, at least in part, a serialization of the resource description graph associated with the computational flow, the one or more functional blocks, or a combination thereof. At least one of the execution and the distribution are based, at least in part, on the serialization, thereby further improving the computation efficiency.

As shown in FIG. 1, the system 100 comprises a set 101 of user equipments (UEs) 107a-107i having connectivity to a computational flow execution platform 103 via a communication network 105. By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UEs 107a-107i are any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

In one embodiment, the UEs 107a-107i are respectively equipped with one or more user interfaces (UI) 109a-109i. Each UI 109a-109i may consist of several UI elements (not shown) at any time, depending on the service that is being used. UI elements may be icons representing user contexts such as information (e.g., music information, contact information, video information, etc.), functions (e.g., setup, search, etc.) and/or processes (e.g., download, play, edit, save, etc.). These contexts may require certain sets of media dependent computational closures, functional blocks, or a combination thereof, which may affect the service, for example the bit error rate, etc. Additionally, each UI element may be bound to a context/process by granular distribution. In one embodiment, granular distribution enables processes to be implicitly or explicitly migrated between devices, computation clouds, and other infrastructure.

In one embodiment, computational flow distribution can be initiated for example by means of unicast (e.g., to just another device) or multicast (e.g., to multiple other devices). For example one UE 107 may communicate with many infrastructures (or many components of many infrastructures), while many nodes of infrastructures may communicate with multiple clouds. Additionally, computational flow distribution may be triggered via gesture recognition, wherein the user preselects a particular set of UI elements and makes a gesture to simulate “pouring” the selected UE elements from one device to another. In other embodiments, computational flow distribution may be initiated automatically without direct user involvement and based on default setup by the manufacturer of the UE 107a-107i, previous setup by the user of the UE, default setup in an application activated on or associated with a UE 107a-107i, or a combination thereof.

As seen in FIG. 1, a user of UEs 107a-107i may own, use, or otherwise have access to various pieces of information and computations distributed over one or more computation clouds 111a-111n in information stores 113a-113m, and computation stores 115a-115m. Each of the one or more computation spaces 115a-115m includes multiple sets of one or more computational closures, one or more functional blocks, or a combination thereof. In one embodiment, the user may be an application developer that uses a UE 107a-107i to connect to the infrastructure and the cloud not only for accessing the services provided for end users but also for activities such as developing, distributing, processing, and aggregating various computations.

In one embodiment, the communication network 105 consists of one or more infrastructures 117a-117k, each of which is a designed communication system including multiple components 119a-119n. The components 119a-119n include backbones, routers, switches, wireless access points, access methods, protocols, etc. used for communication within the communication network 105 or between communication network 105 and other networks. Each infrastructure 117 can interact with UE 107a-107i at an Infrastructure-as-a-Service (IaaS), a Platform-as-a-Service (PaaS) layer, or a Software-as-a-Service (SaaS) layer as defined by the National Institute of Standards and Technology (NIST).

IaaS includes all the system services that make up the foundation layer of a cloud—the server, computing, operating system, storage, data back-up and networking services. Operating at this layer, the infrastructure 117 manages the networking, hard drives, hardware of the server, virtualization O/S (if the server is virtualized), while the UE 107 remotely manage everything else (e.g., applications, data, middleware, runtime, O/S). PaaS includes the development tools to build, modify and deploy cloud optimized applications. Operating at this layer, the infrastructure 117 provides hosted application/framework/tools for UE 107 to build something on. SaaS includes the business applications. Operating at this layer, the infrastructure 117 provides business functionality to UE 107, such that UE 107 does not have to manage any service and all is done by the infrastructure 117.

In one embodiment, the computational flow execution platform 103 controls the distribution of computations associated with UEs 107a-107i to other components or levels of the computational environment including the infrastructure level 117a-117k within the environment of the communication network 105, and the cloud level 111a-111n, based on resource availability associated with different architectural levels and resource consumption requirements of computations.

In one embodiment, computational flow execution may be initiated by the user, or based on a background activity for example by triggering a sequence of computational closures, functional blocks, or a combination thereof, which in turn support distribution process. Prior to computation distribution, the capabilities, including the resources available for performing the computations, are evaluated. If capabilities of an architectural level are not satisfactory or changes in capabilities are found, the evaluation process will continue until proper capabilities become available. The capabilities may be found in different functional blocks that include computational closures on the same or different levels of the computational environment.

In another embodiment, network components 119a-119n may provide different levels of functionality. For example, some components 119a-119n may provide static computational closures, functional blocks, or a combination thereof, while others may provide dynamic computational closures, functional blocks, or a combination thereof. As used herein, a static computational closure or functional block has with predetermined configurations, which in return may require a predefined amount of resources for execution, while a dynamic computational closure or functional block functions differently based on dynamic factors such as time, traffic load, type or amount of available resources, etc. A dynamic computational closure or functional block may adjust itself based on the dynamic factors by modifying parameters such as the amount of reserved resources. For example, a dynamic computational closure or functional block may downgrade itself in order to consume lower amount of resources at the times of low resource availability.

In one embodiment, the amount and type of available resources at a component of the infrastructure 117a-117k may or may not be aligned with the required resources by computational closures, functional blocks, or a combination thereof, of UE 107a-107i through a one to one mapping. This means that the component may need to locate (request) further resources from current or next layer or level of the computational environment. In other words, if the resources between a process and its processing environment are not directly aligned, the processing environment may expand its resources (for dynamic closures) or request additional resources from other components (for static closures) or a combination thereof. In one embodiment, if neither the direct alignment succeeds nor additional resources found, the setup may be aligned with lower resources requirements. The requirements may be lowered, for example by dropping part of the computational components, reducing media requirements (e.g. Reduction of multimedia to voice only or decreasing speed requirements), substituting complex computations with more primitive computations that may produce less accurate, but accurate enough for user's needs, results. Additionally, the satisfaction threshold may be lowered (with service provider and user's agreement) so that a lower level of computation results setup can be considered as satisfactory.

In one embodiment, the computational closures, functional blocks, or a combination thereof, available in multiple levels of device level 101a-101n, infrastructure level 117a-117k, and cloud level 111a-111n are aligned, meaning that all the computational closures, functional blocks, or a combination thereof, are available in every level.

In another embodiment, a super-set of all computational closures, functional blocks, or a combination thereof, is available at cloud level while each lower level has access to a sub-set of the computational closures, functional blocks, or a combination thereof, from its higher (e.g., infrastructure or cloud) level. Additionally, levels of the computational environment may have sets of functionally equivalent computational closures or functional blocks in the sense that they render the same content with different levels of accuracy based upon different levels of resource consumption. For example, a high resolution video providing a set of computational closures, functional blocks, or a combination thereof, may be equivalent to a set of computational closures, functional blocks, or a combination thereof, that produce the same video with a lower levels of resolution based upon lower resource consumption. When configuring a UE 107a-107i, the user may select an option for receiving low resolution due to resource restrictions, e.g., low battery.

By way of example, the UEs 107a-107i, and the computational flow execution platform 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

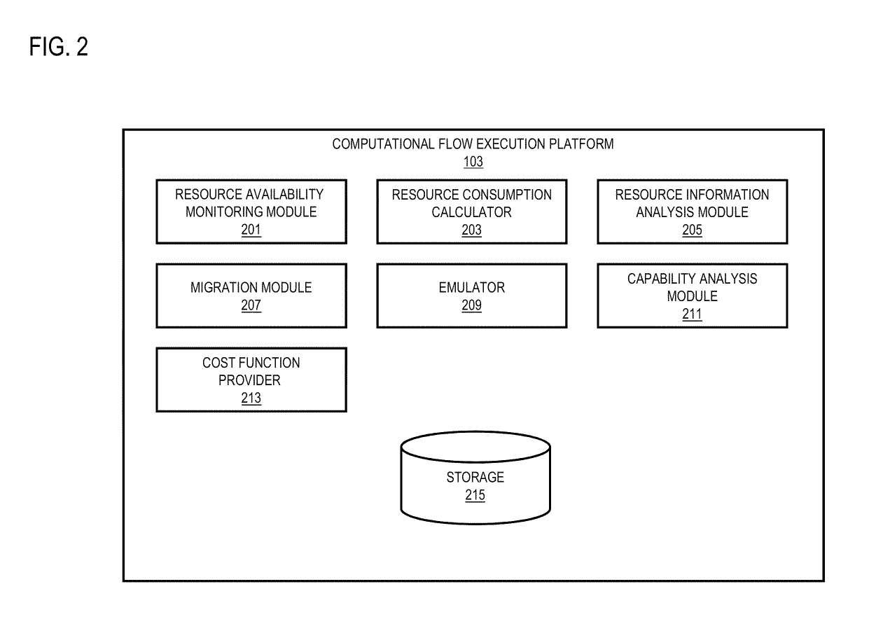

FIG. 2 is a diagram of the components of a computational flow execution platform, according to one embodiment. By way of example, the computational flow execution platform 103 includes one or more components for providing computational flow execution. It is contemplated that the functions of these components may be combined in one or more components or performed by other components of equivalent functionality. In this embodiment, the computational flow execution platform 103 includes a resource availability monitoring module 201, a resource consumption calculator 203, a resource information analysis module 205, a migration module 207, an emulator 209, a capability analysis module 211, a cost function provider 213, and a storage 215.

In one embodiment, following the start of the execution of a computational/functional flow (for example, playing a video on UE 107) the computational flow execution platform 103 is assigned with the task of controlling the distribution of computations related to the computational flow according to resource availability and consumption. The computation distribution may be initiated by the user of UE 107, automatically by UE 107 based on pre-determined settings, by other devices or components associated to UE 107, or a combination thereof. Furthermore, the initiation of computation distribution may trigger the activation of computational flow execution platform 103.

The resource availability monitoring module 201 determines resource availability information associated with respective levels of a computational environment, wherein the respective levels include, at least in part, a device level 101a-101n, an infrastructure level 117a-117k, and a cloud computation level 111a-111n. The determined resource availability can be utilized for deciding at which level each computation should be executed. In one embodiment, the resource availability monitoring module 201 may determine resource availability prior to the start of computational flow distribution. In other embodiments, the resource availability monitoring module 201 may periodically (e.g., based on an initial setup) determine resource availability information associated with different levels of the computational environment, store the determined data in storage 215, in information stores 113a-113m of clouds 111a-111n, or a combination thereof, and retrieve/reuse the stored data when needed. In one embodiment, the resource availability monitoring module 201 may determine and store the resource availability in the RDF format.

The resource consumption calculator 203 determines resource consumption information associated with respective computational closures, functional blocks, or a combination thereof, that is going to be executed on a computational environment 100. The determined resource consumption may depend on various factors such as computation complexity and the processing power required for the computation, the amount of other resources that the computation consumes (e.g., memory space), etc.

In one embodiment, the resource consumption calculator 203 determines resource consumption prior to the start of computational flow distribution. In other embodiments, the resource consumption calculator 203 periodically (e.g., based on an initial setup) determines resource consumption data associated with different sets of computational closures, functional blocks, or a combination thereof, associated with computational flows, store the determined data in storage 215, in information stores 113a-113m of clouds 111a-111n, or a combination thereof, and retrieves/reuses the stored data when needed. In one embodiment, the resource consumption calculator 203 may determine and store the resource consumption in the RDF format. In one embodiment, the resource consumption calculator 203 generates resource consumption information based, at least in part, on the computational flow.

The resource information analysis module 205 processes, analyzes or facilitates processing or analyzing of the resource availability information and the resource consumption information in order to determine an optimum distribution plan among computational closures, functional blocks, or a combination thereof, in the levels of computational environment by the migration module 207, to achieve, for example, a workload balance between resources of local and remote computational levels or any other strategic goals set by users, application developers, device manufacturers, service providers, network operators, etc.

It is noted that determining computation distribution strategies may depend on factors other than resources, such as computational capabilities of various components of architectural levels and of the computational closures, functional blocks, or a combination thereof.

The capability analysis module 211 determines one or more capability parameters associated with the computational closures, functional blocks, one or more levels of the computational environment, or a combination thereof. The one or more capability parameters include, at least in part, one or more resource parameters, one or more security parameters, one or more privacy parameters, or a combination thereof. The determined capabilities can be used by the migration module 207 for deciding which computational closures, functional blocks, or a combination thereof, should be utilized.

In one embodiment, the capability analysis module 211 determines closure/block capabilities following the start of computational flow distribution. In other embodiments, the capability analysis module 211 periodically (e.g., based on an initial setup) determines closure/block capability data associated with different levels of the computational environment, stores the determined data in storage 215, in information stores 113a-113m of clouds 111a-111n, or a combination thereof, and retrieves/reuses the stored data when needed. In one embodiment, the capability analysis module 211 may determine and store the closure/block capabilities in the RDF format.

The emulator 209 determines to cause, at least in part, an emulation of the at least portion of one computational closure, one functional block, or a combination thereof, for the current, or next available, level of computational environment. The emulator 209 generates a functional duplicate of the computational closures, the functional blocks, or a combination thereof, for the target level of the computational environment in order to determine the amount of resources, e.g. Resource consumption for the computational closures on the specific level of computational environment. For example, if the migration module 207 determines a level of computational environment or a component of a level of the computational environment with sufficient available resources to execute a given set of computational closures, the emulator 209 can provide an emulation of the given set of computational closures, the functional blocks, or a combination thereof, that is tailored to the configuration of the determined level (or component) of computational environment and therefore is executable on the determined level (or component).

The cost function provider 213 processes and/or facilitates processing of the one or more parameters, such as resource availability, resource consumption and capability information, to determine a cost value for the computational closures, the functional blocks, or a combination thereof. The cost functions may be defined by application developers, device manufacturers, distributed system management, service providers, or a combination thereof. One or more cost functions may be assigned to each architectural level or to every component of each architectural level. Furthermore, definition of a cost function may take into consideration various factors affecting the cost of computations on a certain component or an architectural level such as resource consumption, resource cost, privacy and/or security enforcement measures, processing power/speed, etc. The determined cost can be utilized by the migration module 207 for deciding at which level of the computational environment each computational disclosure and each functional block should be executed.

In one embodiment, the resource information analysis module 205 determines whether the determined cost by the cost function provider 213 is affordable for the current level of computational environment associated, or going to be associated, with the computational closures. The determination of affordability may include determining whether the available resources at the architectural level are sufficient for the resource consumption level of the computational closures, the functional blocks, or a combination thereof. The determination may also include determining, by the resource availability monitoring module 201, whether any changes in resource availability information has occurred. In one embodiment, if changes of resource availability have occurred, the resource information analysis module 205 utilizes the change information for processing the resource availability information, resource consumption information, or a combination thereof. Subsequently, if the available resources are sufficient for the consumption, migration module 207 transfers the computational closure, the functional blocks, or a combination thereof, to the computational environment levels with sufficient resources available.

In one embodiment, at any step of computation distribution if any changes in the capabilities, computational flows, resource availability, resource consumption, or any other parameters of the network are recognized (not shown) (e.g., power shut down, fault in a component, etc.) which may affect the distribution process, the resource availability monitoring module 201, the resource consumption calculator 203 and the capability analysis module 211 may reevaluate the capabilities, availabilities and consumption, and the process will restart from the beginning. Alternatively if no change occurs, the distribution process may be performed by the migration module 207.

It is noted that the determination of resource availability, resource consumption or computation capabilities may be performed either statically, dynamically, or a combination thereof. In the case of static determination, the resource availability, resource consumption or computation capabilities are determined prior to start of computation distribution process and the results are stored for migration module 207 to refer to. Under the static status, the computational closures may be static as well meaning that the closures may consist of pre-coded, preprocessed, pre-computed functions or functions that their availability has been previously insured. As for static closures and functional blocks, all the states of closures/blocks and functions are pre-computed so that a particular input will always produce the same output and the internal states remain unchanged.

Alternatively, the resource availability, resource consumption or computation capabilities may be dynamically monitored prior to and during the computation distribution and whenever diagnosing an unsatisfactory condition alert the migration module 207. In any case, the resource availability, resource consumption or computation capabilities determined may not be satisfactory for computation distribution; or the evaluation process may diagnose changes in the capabilities. For example, excessive work load, congestion, technical problems, or power shutdown at an architectural level or at a component of the architectural level may result in unsatisfactory status of the level or the component for computation distribution. In this case, the computational flow execution platform 103 recalculates the resource availability, resource consumption or computation capabilities, and the needed level of computational closure is re-evaluated by the computational flow execution platform 103. In this case, the closures may be dynamic, wherein the code is constructed during the execution and furthermore, the internal state of the execution may vary. Also, the output of the computational closures, functional blocks, or a combination thereof, may change based on dynamically determined resource availability, resource consumption and computation capabilities.

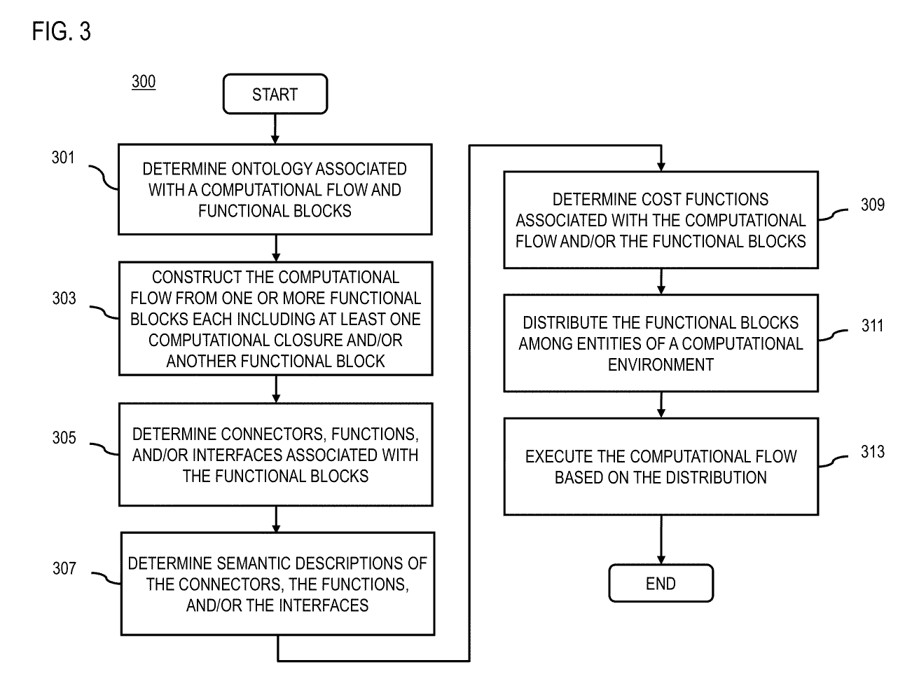

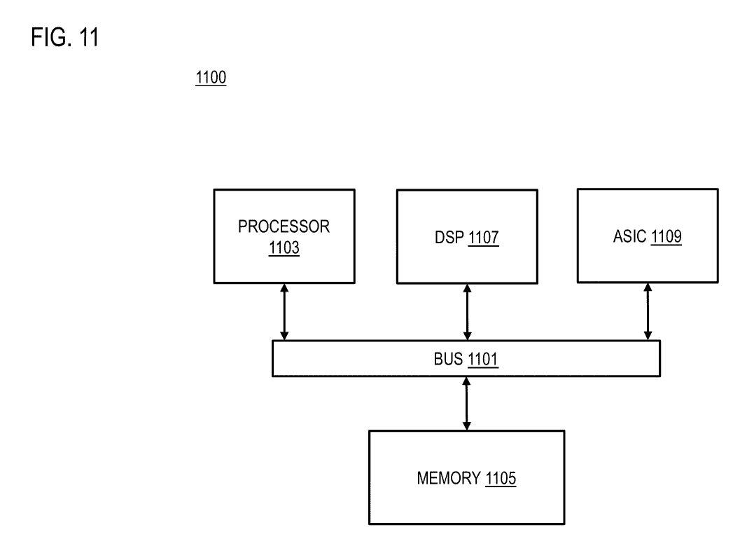

FIG. 3 shows a flowchart 300 of a process for providing computational flow execution providing computational flow execution with functional blocks, according to one embodiment. In one embodiment, the computational flow execution platform 103 performs the process 300 and is implemented in, for instance, a chip set including a processor and a memory as shown in FIG. 11. In step 301, the computational flow execution platform 103 determines one or more ontologies associated with the at least one computational flow, the one or more functional blocks, or a combination thereof. Ontology is a common representation of a set of concepts within a domain and the relationships between those concepts. The computation ontology describes different kinds of elementary functionalities that the system 100 supports and different topologies of parameters which could be outputs or inputs of computations. By way of example, the ontologies agree and adopt new vocabularies using Resource Description framework (RDF) and RDFS (RDF schema). When RDFS is not sufficient for defining and instantiating the ontologies, web ontology language (OWL) or the like may be used.

In step 303, the computational flow execution platform 103 determines to cause, at least in part, a construction of at least one computational flow (e.g., playing Dave Stewart #1 hit song at UE 107a) from one or more functional blocks (e.g., Block 1: searching all Dave Stewart hit songs, Block 2: selecting #1 among the hit songs, Block 3: playing American Prayer, etc.).

In one embodiment, the computational flow is represented as an RDF graph consisting of predefined elementary functionalities interconnected through their parameters. During execution, the functional blocks at the beginning of the functional flow which are able to execute performs the computations and write the results in a shared knowledge base allowing the block that depends from this result to be notified of the new input and so to start themselves in order to bring on the overall process of calculating the results of the flow.

A computational flow is executable by the system because it is made up of a sequence of known elementary functionalities and it is itself a functionality by construction, forming a new type of functionality. The programmer is free to compose flows of blocks and also to use them as blocks for more complicated algorithms. The system 100 only requires from an application developer a functional description while the computation flow can be partially decided by the system 100 according to context dependent parameters, such as application requirements, and the currently available resources. If the system decides to send a functional flow for cloud execution then a remote entity can make decisions about execution strategy by taking in considerations remote resources. The execution is not blocking, so while a computational flow is in execution phase, the rest of the main program may go on until the values from the chain are needed. Each programming language can be adapted to the described framework by supporting opportunistic definition and translation into the semantic format of the basic blocks and their connections. The RDF graph representing the computational flow is represented in a dataflow and can therefore be executed by optimizing for different domain specific parameters, e.g. Parallelism. The code that can be written using the basic functionalities can be general because the framework may support many data type, standard, user defined, vectorial functions, etc.

Functions (and so elementary blocks or flows of them) can be considered first class entities to be combined with other blocks (with matching input or output interface). Sets of orthogonal complete functions could be identified to properly manage a certain domain of interest (e.g. Image compression, voice data processing, etc.). This allows further optimization of the representation and execution flow which can extend down to a possible mapping to hardware description languages (e.g. VHDL, Verilog, etc.).

The one or more functional blocks include, at least in part, one or more computational closures, one or more other functional blocks, or a combination thereof. By way of example, Block 1: “searching all Dave Stewart hit songs” includes another functional block (e.g., Block 4: searching all Dave Stewart songs), and a computational closures (e.g., filing Dave Stewart songs with a criterion of sold more than one million copies).

In step 305, the computational flow execution platform 103 determines one or more connectors (e.g., between Block 1 and Block 2), one or more functions (e.g., using outputs of Block 1 as inputs of Block 2), one or more interfaces (e.g., an output interface of Block 1, an input interface of Block 2), or a combination thereof, associated with the one or more functional blocks. The computational flow execution platform 103 describe semantically the components of the flow (connectors, functional blocks, interfaces etc.) using the ontology.

The one or more connectors, the one or more functions, the one or more interfaces, or a combination thereof are specified with respect to one or more inputs (e.g., Dave Stewart songs, Dave Stewart hit songs, etc.), one or more outputs (e.g., Dave Stewart #1 hit song), or a combination thereof of the at least one computational flow, the one or more functional blocks, or a combination thereof.

Connectors transfer information and data associated with a closure/block and its execution results to the next closure/block in the branch or to other branches. Additionally, connectors may function as links between related branches that constitute a distributed computation.

In step 307, the computational flow execution platform 103 processes and/or facilitates a processing of the one or more ontologies to determine one or more semantic descriptions of the one or more connectors, the one or more functions, the one or more interfaces, or a combination thereof.

In step 309, the computational flow execution platform 103 determines one or more cost functions associated with the at least one computational flow, the one or more blocks, or a combination thereof. Each element of the computational flow may be associated with a cost function or value, which can be used by the system as parameters for optimization.

The one or more cost functions relate, at least in part, to one or more resources (e.g., Blu-ray player, sensed physical values including a temperature, location, etc. of the Blu-ray player or of the environment the Blu-ray player is situated, etc.), one or privacy policies (e.g., consumer credit card numbers only available for authorized merchants), one or more security policies (e.g., digital right management (DRM) compliant, authentication, etc.), or a combination associated with the one or more entities.

In step 311, the computational flow execution platform 103 processes and/or facilitates a processing of the at least one computational flow, the one or more functional blocks, or a combination thereof to cause, at least in part, a distribution of the one or more functional blocks among one or more entities of a computational environment. By way of example, the entities include a router for processing Blocks 1-3, a Blu-ray player in the proximity of UE 107a or a Blu-ray convertor for converting the Blu-ray signals into a format compatible with the player built in UE 107a, etc.

In step 313, the computational flow execution platform 103 causes, at least in part, an execution of the at least one computational flow, the one or more functional blocks, or a combination thereof based, at least in part, on the distribution. In various embodiments, the distribution and/or execution is based, at least in part, on the ontologies, the semantic descriptions, and/or the cost functions.

By way of example, an entity accesses an information store, an information space, a cloud, or a combination thereof, with basic operations including Insert (to insert information thereinto), Remove (to remove information therefrom), Update (to update information therein, which is effectively an atomic remove and insert combination), Query (to query for information therein), Subscribe (to set up a persistent query therein such that a change in the query results is communicated to the subscribing entity), etc.

Once suitable result has been obtained, the entity which published the functional flow is either informed by a subscription mechanism or it queries the information store to detect the emergence of the result.

The entity which published the functional flow may also participate in the computation of the flow. This may occur when this entity has rudimentary piece of information not available for other nodes. By way of example, a mobile device wants to continuously obtain the best possible route to target on a map based on its current location. The current location can only be meaningfully computed by the mobile device, even if the route calculation is done by other nodes.

In one embodiment, the computational flow execution platform 103 processes and/or facilitates a processing of the one or more semantic descriptions to cause, at least in part, the execution, the distribution, or a combination thereof to be performed in parallel among the one or more entities. Therefore, the computation flow is accelerated.

In one embodiment, the at least one computational flow, the one or more functional blocks, or a combination thereof are represented, at least in part, in at least one data structure of at least one information space, at least one information store, at least one cloud computing component or a combination thereof; and the one or more costs functions are associated with the at least one data structure (e.g., the RDF format). In this embodiment, the computational flow execution platform 103 causes, at least in part, an exchange of the at least one data structure via a publish/subscribe mechanism. Once a semantic description is represented in a RDF format, it can be published to an information store. In a semantic form, the RDF graph can be interpreted by (other, distinct, distributed) entities with access to the information store. In the simplest example, the description is read in by a single entity. Upon completion of the execution (or a suitable checkpoint during the execution), results (or intermediate results) are published back to the information store.

The data structure may be any predetermined information representation format or structure or structure (e.g., a RDF graph). To simplify the discussion, RDF graphs are used as one example of representation format. In one embodiment, RDF graphs represent resources with classes, properties, and values. A node/resource is any object which can be pointed to by a uniform resource identifier (URI), properties are attributes of the node, and values can be either atomic values for the attribute, or other nodes. RDF Schema provides a framework to describe ontology-specific classes and properties. Classes in RDF Schema are like classes in object oriented programming languages. This allows resources to be defined as instances of classes, and subclasses of classes.

RDF graphs are used to join data from vocabularies of different domains (such as business domains), without having to negotiate structural differences between the vocabularies. In addition, the RDF allows merging the information of the embedded domains with the information in the clouds, as well as to make the vast reasoning and ontology theory, practice and tools developed by the semantic web community available for developing cloud applications.

Each RDF-graph includes a set of unique triples in a form of subject, predicate, and object, which allow expressing graphs. For example, in this piece of information “Dave Stewart #1 hit song is American Prayer,” the subject may be Dave Stewart #1 hit song, the predicate may be is, and the object may be American Prayer. The simplest RDF-graph is a single triple. Any node or entity can store unconnected graphs. This approach can be adapted in a smart space that includes the semantic web and has distributed nodes and entities that communicate RDF-graphs of the at least one computational flow (e.g., playing Dave Stewart #1 hit song at UE 107a), the one or more functional blocks (e.g., Block 1: searching all Dave Stewart hit songs, Block 2: selecting #1 among the hit songs, Block 3: playing American Prayer, etc.), the one or more connectors (e.g., between Block 1 and Block 2), the one or more functions (e.g., using outputs of Block 1 as inputs of Block 2), the one or more interfaces (e.g., an output interface of Block 1, an input interface of Block 2), the cost functions (e.g., of the blocks), or a combination thereof.

The computational flow execution platform 103 causes, at least in part, a serialization of one or more resource description graphs associated with the at least one computational flow, the one or more functional blocks, or a combination thereof. Continuing with the same example, “Dave Stewart” can be encode into “100,” “#1 hit song” can be encode into “011,” “is” can be encoded into “010” and “American Prayer” can be encoded into “111.” As such, “Dave Stewart #1 hit song is American Prayer” is serialized as 100 011 010 111. The serialized RDF graphs are easy to transmit and manipulate in many ways. In various embodiments, the execution, the distribution, or a combination thereof is based, at least in part, on the serialization.

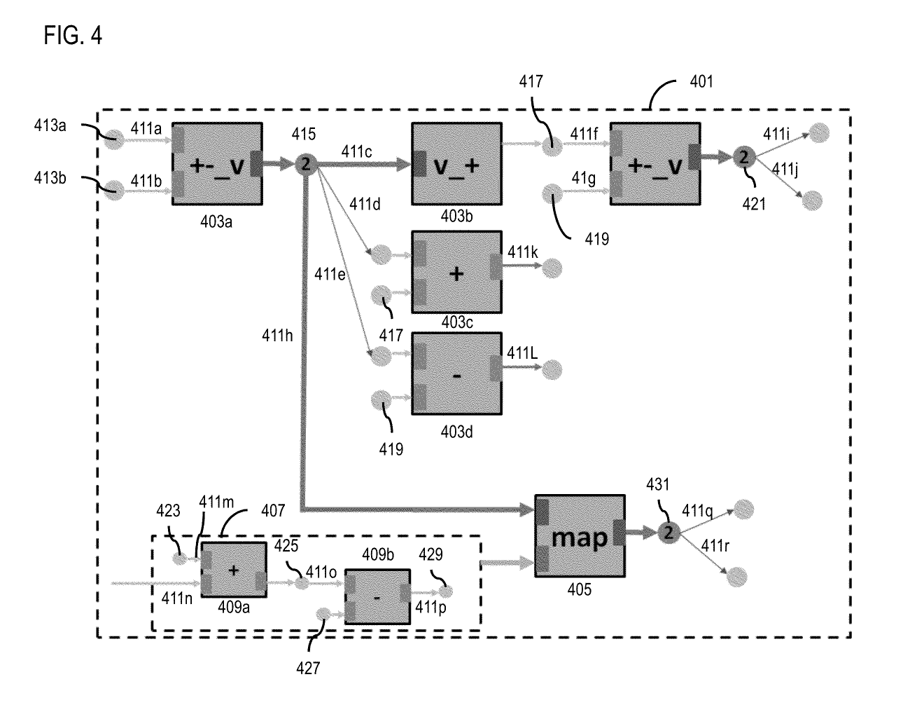

FIG. 4 is a representation of computation distribution and computational flow execution, according to one embodiment. The computation distribution starts at a component of an architectural level (not shown). Each component may execute a set of closures, blocks, or a combination thereof, of a computational flow 401.

The different arrows and their points of contact with the blocks (e.g., ports) in FIG. 4 represent the flow of the different types of parameters supported by the system 100. There are simple parameters (i.e. Integer), vectorial parameters (e.g., containers of simple parameters of the same type), and functional parameters. In FIG. 4, dashed lines enclose two functional blocks, and so all the picture represents a computational flow, the functional blocks, the computational disclosures, or a combination thereof is translatable to a RDF format according to the computation ontology.

For example, the computational flow 401 is composed of closures 403a-403e, a functional block 405, and a functional block 407. In one embodiment, the functional block 407 is composed of closures 409a-409b. Every two consecutive closures are connected via a connector and functional blocks are communicating via connectors as well. For example, connectors 411a and 411b connect inputs 413a, 413b to closure 403a. Closure 403a executes a “+−vec function” that uses two inputs 413a, 413b to generate a vectorial output 415 containing the sum and the difference of the inputs 413a, 413b.

Connectors 411c-411h connect output the vectorial output 415 of closure 403a to closures 403b-403d and functional block 405. Closure 403b executes a “vec+ function” that uses output 415 as a vectorial input to generate a single output representing the sum. The sum is output 417 via connector 411f to closure 403e. Closure 403e executes a “+−vec function” that uses two inputs 417, 419 to generate a vectorial output 421 containing the sum and the difference of inputs 417, 419. The vectorial output 421 is output via connectors 411i, 411j.

Closure 403c executes a “+ function” that uses vectorial output 415 and an input 433 to generate a single output representing the sum of vectorial output 415 and input 433. The sum is output via connector 411k. Closure 403d executes a “− function” that uses vectorial output 415 and an input 435 to generate a single output representing the difference of vectorial output 415 and input 435. The difference is output via connector 411l.

Connectors 411m and 411n connect inputs 423a, 423b to closure 409a of functional block 407. Closure 409a executes a “+ function” that uses inputs 423a, 423b to generate a single output representing the sum 425 of inputs 423a, 423b. The sum 425 is output via connector 411o to closure 409b. Closure 409b executes a “− function” that uses sum 425 and an input 427 to generate a single output representing the difference 429 of vectorial sum 425 and input 427. The difference 429 is output via connector 411p to functional block 405.

In one embodiment, the functional block 405 is a map that applies a higher order function to each elements of an input vector (i.e., difference 429 and vectorial output 415) in order to calculate elements of an output vector 431. The output vector 431 is output via connectors 411q, 411r.

By way of example, the computation flow of FIG. 4 corresponds to the following pseudocode, which demonstrates the features, as follows in Table 1:

TABLE 1

| | |
|---|---|
| Input in1,in2,in3,in4,in5,in6in7,in8. | // Incoming parameters |
| Output o1,o2 | // Output |
| ArrayOutput = o3,o4 | |
| x1 = in1+in2; | // Just some internal computation |
| | over input |
| x2 = in1 −in2; | |
| X=(x1,x2); | // Construct an array using local |
| | values |
| o1=x1+in3; | // More internal computation |
| o2=x2− in4 | |
| foreach s in X | // Go through the array |
| y= y+s; | |
| o3_1= = y + in5; | // More internal computation |
| o3_2 = y − in6; | |
| o3 = (o3_1, o3_2); | // Construct a part of the output |
| o4 = map (X, f( , in7, in8)); | // Construct second part of the |
| | // output using the map primitive |
| define f i1 i2 i3 | // The function to apply using map |
| { | |
| Return i1 + 12 −13; | |
| } | |

Connectors may also transfer information and data associated with a closure/block and its execution results to the next closure/block. Additionally, connectors may function as links between related branches that constitute a distributed computational environment.

In one embodiment, connectors may contain information about parameters such as resource availability, resource consumption, capabilities, computational flows, distribution maps, links between closures and architectural levels, etc. arrows connecting closures/blocks to connectors and to next closures/blocks show the computational flow adopted based on the parameters.

In one embodiment, the closures 403a-403e may be executed by UE 107a-107i, the block 405 may be executed by a component of the infrastructure 117a-117n, and the block 407 may be executed by another component of the same infrastructure, a different infrastructure, in a cloud, or a combination thereof.

In one embodiment, connectors may contain information about parameters such as capabilities including resource availability and resource consumption, cost function, computational flow specifications, distribution maps, links between closures and architectural levels, etc. arrows connecting closures/blocks to connectors and connectors to next closures/blocks show the computational flow adopted based on the parameters. For example, the capability parameters are provided by the resource availability monitoring module 201, resource consumption calculator 203 and the capability analysis module 211 and associated with each closure/block respectively. Additionally, cost values are provided for one or more closures/blocks by the cost function provider 213. By way of example, a cost value shows the cost for binding two closures via a connector. In one embodiment, if the value of certain parameters, such as resource cost, based on the analyses by the resource availability monitoring module 201, resource consumption calculator 203, and capability analysis module 211 exceed a certain thresholds, some computational closure or functional block may be omitted from the computational flow, for the value to be reduced. The closures/blocks may be initially assigned with priority levels, so that less important closures/blocks can be omitted if necessary.

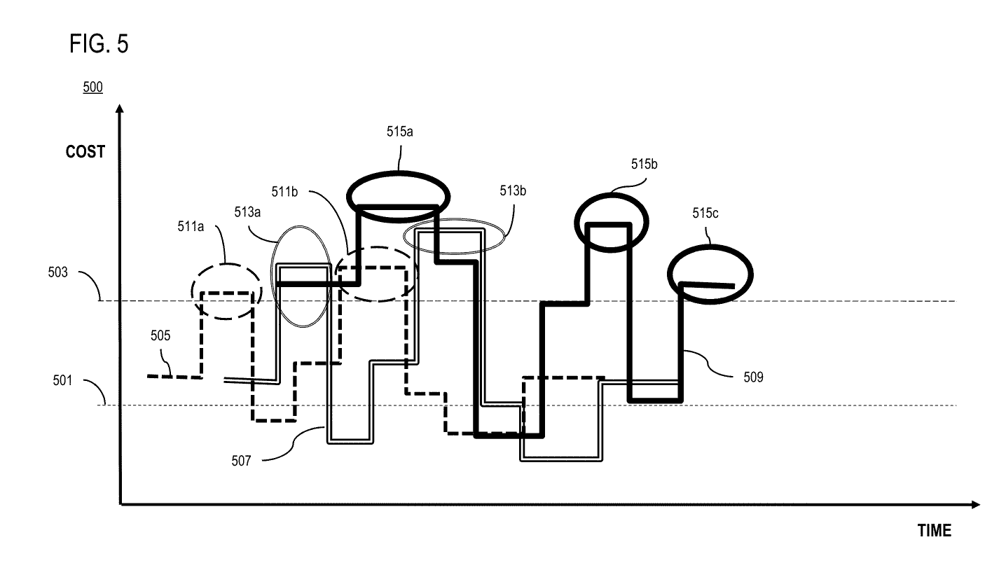

FIG. 5 is a diagram of cost estimation when various capabilities are involved, according to one embodiment. The diagram 500 of FIG. 5 shows computation cost values with respect to time. In one embodiment, resource cost, security cost and privacy cost are considered. In the example of FIG. 5 three curves 505, 507, and 509 represent resource cost, privacy cost and security cost respectively. The two horizontal lines 501 and 503 show the minimum and maximum cost thresholds, meaning that where the cost curves exceed the maximum threshold is the time when distribution of computations may be considered in order to lower the costs. For example, the resource cost 505 exceeds the maximum threshold 503 at points identified by circles 511a and 511b. Similarly, the privacy cost 507 exceeds the maximum threshold at points 513a and 513b, while security cost 509 exceeds the threshold at points 515a, 515b, and 515c.

In one embodiment, a balance between the costs of various capabilities can be created. For example, if application of a certain privacy rule required excessive resource use, parts of the privacy may be omitted in order to avoid excess resource consumption. In this embodiment, the computations of one or more computational closures, one or more functional blocks, or a combination thereof, may be migrated to resources of other levels of the computational environment, for example from device to infrastructure or from infrastructure to the cloud, when the combined cost of resource, privacy, and security exceeds the maximum threshold. Additionally, the computation cost can be considered as a function (F) of three variables E (resource cost), P (privacy cost) and S (security cost) as F (E, P, S)=x*E+y*P+z*S, where x, y, and z are factors identifying the importance (weight) of each cost item for the computation. For example, in order to manage the total cost F of a functional block remains unchanged when limited resources is available, y or z factors can reduce the privacy and security cost. In one embodiment, the values of factors x, y, and z can be interpreted by the computational flow execution platform 103 based on predetermined setups by the user, application developer, device manufacturer, service provider, or a combination thereof.

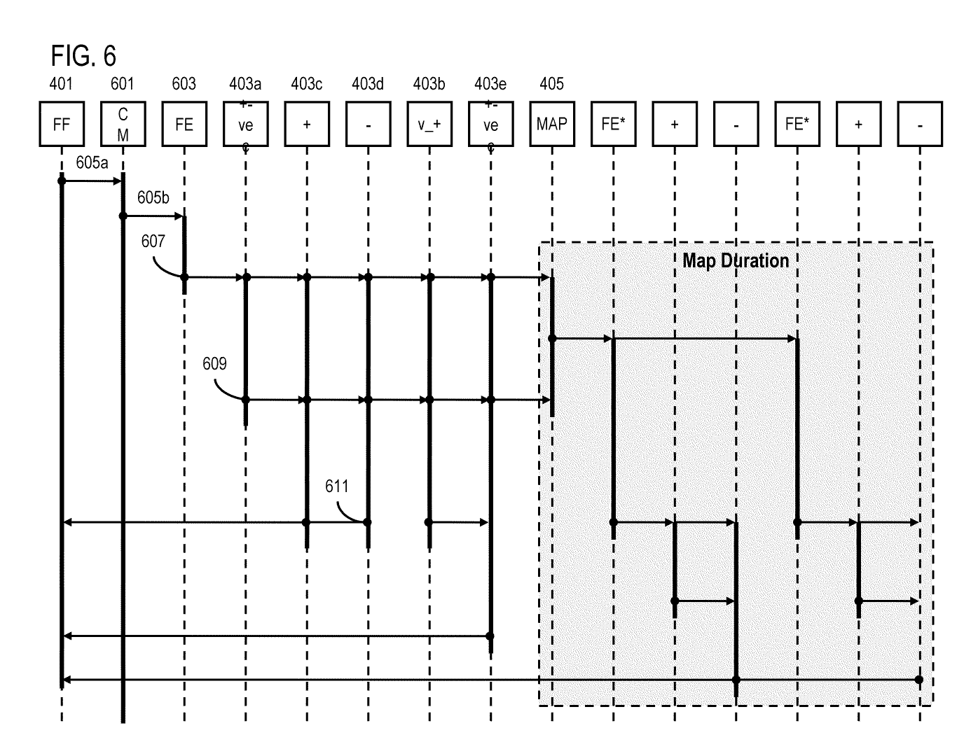

FIG. 6 is a diagram of parallel computation of a computational flow, according to one embodiment. By way of example, the functional flow (FF) 401 is started by sending the serialized computation to the computational flow execution platform 103 and or a computational manager (CM) 601 through a notification mechanism 605a. The signature computational manager (CM) 601 may be configured to work in conjunction with semantic information brokers (SIB) that reside in information stores.

A flow executor (FE) 603 is then started by a notification mechanism 605b, and consequently all the closures and blocks which compose the functional flow are executed. FE* stands for the FE 603 operates in the context of a map execution in conjunction with the functional block 405. By way of example, the output 607 of FE 603 is processed by closures, 403a 403c, 403d, 403b and 403e, and then reaches the map functional block 405. Meanwhile, the output 609 of closure 403a is processed by closures 403c, 403d, and 403b, and then reaches the map functional block 405. In an opposite direction, the output 611 of closure 403d is processed by closure 403c, and then reaches FF 401. The topology of the execution strategy varies depending upon the cost functions of the components in the computational environment. By way of example, there may be several active entities computing the same functional flow or a functional block for the same parameters, as in a race of which will produce results first.

Blocks/closures whose inputs correspond to outputs of other blocks/closures yet to computed will wait to be notified of the input data. In the embodiment of FIG. 6, the execution strategy optimizes parallelism, to execute with as much parallel computation as possible. However, it is also possible to have several entities interpreting different parts of the functional chain to produce an essentially parallel computing of the chain. In this case, the required scaffolding and internal structure of the computation is also described by the data structure in the same ontology as above. This may be implemented by a dedicated active entity, which controls the orchestration of the results produced by the different computational entities and the passing of the parameters for a particular instance of the computation described by the computational flow. Execution of a single elementary function is similar to executing one complete chain by a single entity. In FIG. 6, each vertical line links computational operations with entities (e.g., FF, CM, CE, closures, block, etc.)

In another embodiment, other cost functions take priority over parallelism. Although the execution strategy currently implemented by the computational flow execution platform 103 is optimizing parallelism, but the platform 103 supports extensibility and flexibility so new strategies may be implemented as needed. For example, in the case represented, an execution strategy scarifies performance for saving memory or resources via serializing computation and reusing resources.

The current implementation consists of java classes for both the client side and the server side. Taking the top half of the block diagram in FIG as an example, the five closures 403a-403e (excluding the map functional block 405) can be implemented by the following code fragment in Table 2:

TABLE 2
String[ ] inputs;

String[ ] inputsRef;
Vector<String[ ]> VecInputs;
Vector<String> InReferences;
MapVectorParameter(“a”, 2);
MapVectorParameter(“e”, 2);
String[ ] outputsRef = new String[1];
inputs = new String[2];
inputsRef = new String[2];
VecInputs = new Vector<String[ ]>( );
InReferences = new Vector<String>( );
//String[ ] inValues = {“1”, “2”, “3”};
VecInputs.add(null);
InReferences.add(“a”);
outputsRef = new String[1];
outputsRef[0] = “d”;
addVecFunctionCall(OntologyVocabulary.AddVectorIntClosure,

VecInputs,InReferences, null, null, null, outputsRef);

inputs[0] = null;
inputs[1] = “2”;
inputsRef[0] = “a_0”;
inputsRef[1] = null;
outputsRef = new String[1];
outputsRef[0] = “b”;
addFunctionCall(OntologyVocabulary.AddIntClosure,
inputs,inputsRef, outputsRef );
inputs[0] = null;
inputs[1] = “6”;
inputsRef[0] = “a_1”;
inputsRef[1] = null;
outputsRef = new String[1];
outputsRef[0] = “c”;
addFunctionCall(OntologyVocabulary.SubIntClosure,
inputs,inputsRef, outputsRef );
inputs[0] = “30”;
inputs[1] = “5”;
inputsRef[0] = null;
inputsRef[1] = null;
outputsRef = new String[1];
outputsRef[0] = “a”;
addVecFunctionCall(OntologyVocabulary.AddSubVecIntClosure,

null,null, inputs, inputsRef, outputsRef, null);

```
inputs[0] = null;
inputs[1] = “70”;
inputsRef[0] = “d”;
inputsRef[1] = null;
outputsRef = new String[1];
outputsRef[0] = “e”;
addVecFunctionCall(OntologyVocabulary.AddSubVecIntClosure,
null,null, inputs, inputsRef, outputsRef, null);
Vector<Vector<String>> triples= newVector<Vector<String>>( );
String SIB_Host = SibConstants.SIB_Host;
int SIB_Port = SibConstants.SIB_Port;
String SIB_Name = SibConstants.SIB_Name;
boolean ack = false;
this.kp = new KPICore(SIB_Host, SIB_Port, SIB_Name);
this.xmlTools = new SSAP_XMLTools(null,null,null);
kp.setEventHandler(this);
String xml=“”;
xml=kp.join( );
ack=xmlTools.isJoinConfirmed(xml);
System.out.printIn(“Join confirmed:”+(ack?“YES”:“NO”)+“\n”);
if(!ack)
{
    System.out.printIn(“Can not JOIN the SIB”);
    return ;
}
createSubscriptionsForFinalResults( );
triples= serializeTriplesAsExecutable( );
```

xml= kp.insert(triples);

ack=xmlTools.isInsertConfirmed(xml);

The above code is executed by the computational flow execution platform 103 when a computation made up of the five interconnected closures 403a-403e is initialized and sent to platform 103 or the SIBs. Each closure is added to the computation by addVecFunctionCall( ) or addFunctionCall( ). Closures 403a, 403b, and 403e are added to the computation by addVecFunctionCall( ). Closures 403c and 403d are added to the computation by addFunctionCall( ).

The arguments of the functions of these closures are similar and can be fused into one. All the existing closures can be added to the computation in a modular way. The arguments of the method which adds closures to the computation are initialized and then used. Existing inputs, missing inputs and references made through local identifiers are specified as closures connections. A closure is started when its inputs are ready. In one embodiment, a closure with missing inputs is sent to platform 103 or the SIB so as to fill the missing inputs by some other interacting agent or later by the same agent. Only the part of a computation depending from a missing input will wait for the missing input.

When local identifiers are used to specify closure connection, two equal identifiers are reflected in an equality of the URI of the corresponding parameters. The same URI means a semantic connection between the closures at the information level that allows proper reconstruction and execution by available resources.

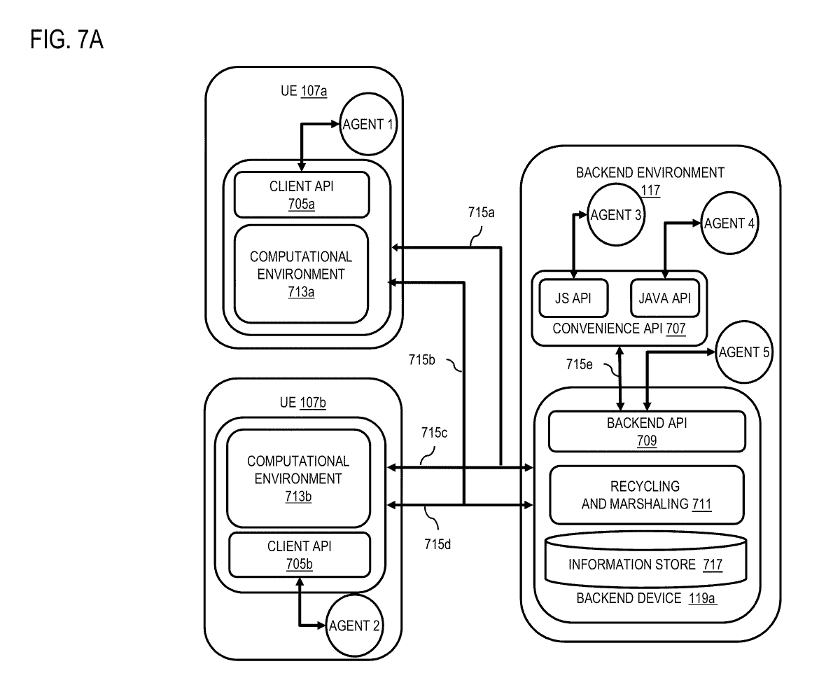

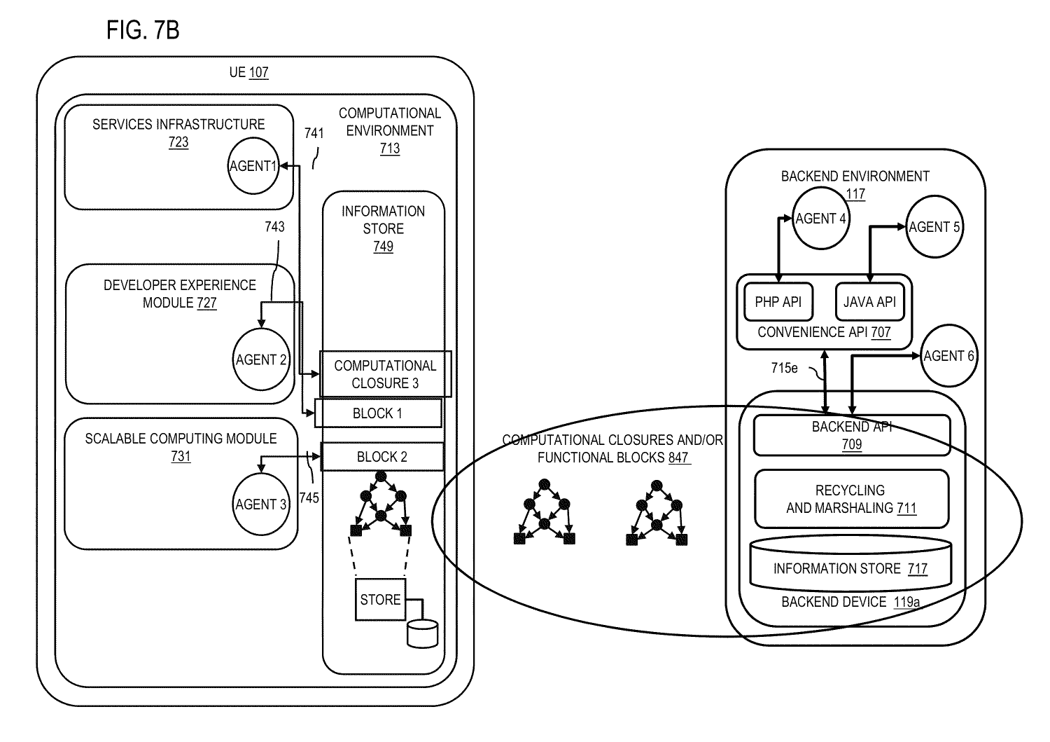

FIGS. 7A-7B are diagrams of computation distribution among devices, according to one embodiment. In one embodiment, in FIG. 7A, the backend environment 117 is a network infrastructure. As discussed, the infrastructure 117 can interact with UE 107a-107i at the IaaS layer, the PaaS layer, or the SaaS layer, to allow UE 107 to remotely manage different services. The backend environment may also be a virtual run-time environment within a cloud 111 associated with the owner of UE 107a or on another UE 107b associated with the user. The backend environment 117 may include one or more components (backend devices) 119a and one or more Application Programming Interface (API) such as a convenience API 707 that may include APIs tailored to the software development environments used (e.g. JAVA, PHP, etc.). Furthermore, UEs 107a and 107b may include client APIs 705a and 705b. Each API enables interaction between devices and components within another device or a computational environment. For example, backend API 709 enables interaction between the backend device 119a and Agent5, and convenience API 707 enables interaction between the backend device 119a and agents Agent3 and Agent4, wherein each agent is a set of processes that handle computational closures, functional blocks, or a combination thereof, within the backend environment 117. APIs 705a and 705b enable interaction between UE 107a and agent Agent1, and UE 107b and Agent2 respectively. As seen in the example of FIG. 7A, Agent3 works under PHP while Agent4 is a JAVA process. Each of the UEs 107a and 107b has a computational environment 713a and 713b which may be part of a cloud 111. Arrows 715a-715e represent distribution path of computational closures, functional blocks, or a combination thereof, among the environments 713a, 713b and the information store 717. The information store 717 is a repository of computational closures, functional blocks, or a combination thereof, that can be accessed and used by all the UEs and infrastructure components having connectivity to the backend environment 117.

In one embodiment, the backend device 119a may be equipped with a recycling and marshaling component 711 that monitors and manages any access to the information store 717. In other embodiments the recycling and marshaling (i.e. Standardization for uniform use) may be a function of the computational flow execution platform 103.

In one embodiment, the computational closures, functional blocks, or a combination thereof, within environments 713a, 713b and the information store 717 may be composed based on anonymous function objects and automatically created by a compiling system using methods for generating anonymous function objects such as lambda expressions.

FIG. 7B is an expanded view of a computational environment 713 as introduced in FIG. 7A. The computational environment 713 may be composed of components for generating one or more computational closures, one or more functional blocks, or a combination thereof. In one embodiment the computational environment 713 has a services infrastructure 723 that provides various services for the user of the UE 107. The services may include any application that can be performed on the UE 107 such as, games, music, text messaging, voice calls, etc. In one embodiment, the services infrastructure 723 provides support for computational distribution under the supervision of a computational flow execution platform 103 as discussed in FIG. 1, FIG. 2, and FIG. 3. The agent Agent1 retrieves the computational closures, the functional blocks, or a combination thereof, as required by the services infrastructure 723 from the information store 749 and stores the newly generated computational closures, functional blocks, or a combination thereof, by the services infrastructure 723 into the information store 749 for distribution purposes per arrow 741.

In another embodiment, the computational environment 713 has a developer experience module 727 that provides various tools for a developer for manipulating services offered by the UE 107. The tools may include standardized and/or abstract data types and services allowing the developers to flow processes together across development platforms. In one embodiment, the developer experience module 727 provides cross platform support for abstract data types and services under the supervision of a computational flow execution platform 103 as discussed in FIG. 1. Agent2 retrieves the computational closures, the functional blocks, or a combination thereof, required by the developer experience module 727 from the information store 749 and stores the newly generated computational closures, functional blocks, or a combination thereof, by the developer experience module 727 into the information store 749 for distribution purposes per arrow 743.

In yet another embodiment, the computational environment 713 has a scalable computing module 731 that provides an abstract wrapper (i.e. Monadic wrapper) for a functional block. This abstraction provides computation compatibility between the functional block and the UE 107. The abstract wrapper may provide scheduling, memory management, system calls and other services for various processes associated with the functional block. These services are provided under the supervision of the computational flow execution platform 103 as discussed in FIG. 1. Agent3 retrieves the computational closures, the functional blocks, or a combination thereof, required by the scalable computing module 731 from the information store 749 and stores the newly generated computational closures, the functional blocks, or a combination thereof, by the scalable computing module 731 into the information store 749 for distribution purposes per arrow 745. In one embodiment, the backend environment 117 may access the information store 749 and exchange/migrate one or more computer closures, the functional blocks, or a combination thereof 747 between the information store 749 and the backend information store 717.

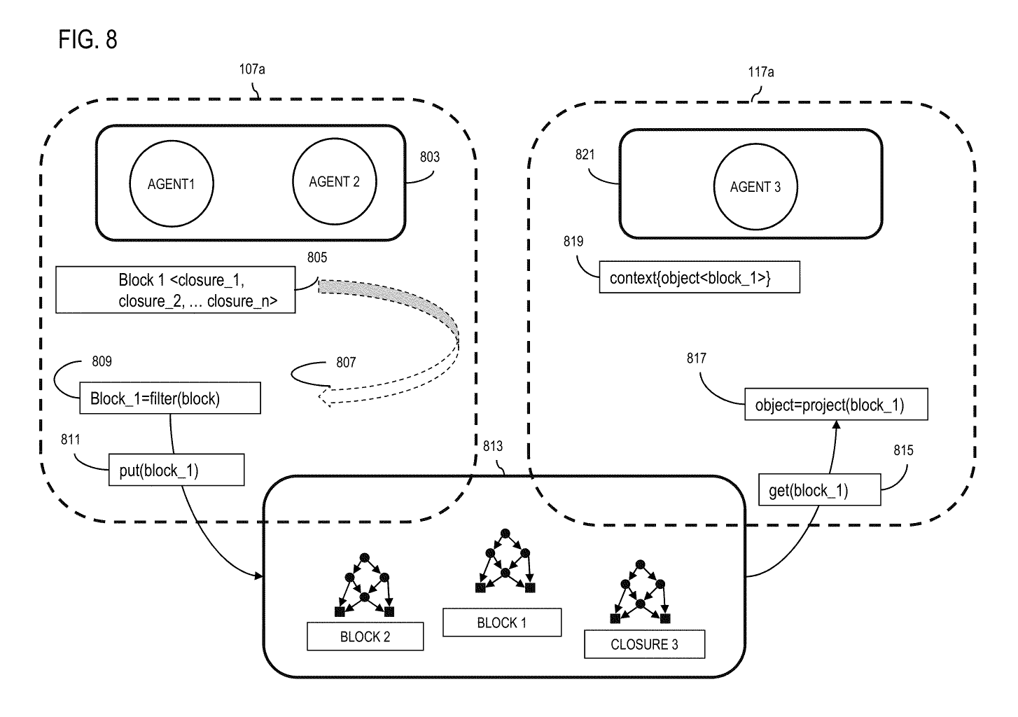

FIG. 8 is a diagram of computational flow distribution from a device to a backend environment, according to one embodiment. In one embodiment, the device 107 is a UE associated with the user. The backend environment 117 may include one or more components, such as backend devices 119 (e.g., router, server, etc.). The UE 107 may include a user context 803 which is being migrated among devices. Agent1 and Agent2 are processors that calculate and handle computational closures, functional blocks, or a combination thereof, within the user context 803. The number of agents may be different in different devices based on their design, functionality, processing power, etc. Block 805 represents a functional blocks including a set of computational closures, closure_{—}1, closure_{—}2, . . . , and closure_n, where each closure is a component of a process, for example, related to a service provided to the user by the user equipment 107. Each closure is a standalone process that can be executed independently from the other closures. In the example of FIG. 8, the filtering process 807 extracts block_{—}1 from an information space 805 via filtering the set (shown in block 809). The extracted block_{—}1 is added to an information store 813 using the exemplary Put command 811.

It is assumed, in this example, that a component of the backend environment 117 (not shown) is selected by the computational flow execution platform 103 as a destination for computational distribution from UE 107. The extracted functional block, block_{—}1 is migrated to the component by the migration module 207 of the computational flow execution platform 103, and executed on the component.

In one embodiment, the component receives the functional block block_{—}1 and extracts it from the information store 813 using the Get command 815. The extracted block_{—}1 is projected into a computational environment with the user device context and the object 817 is produced. The block 819 represents the reconstruction of the block into the initial context by a component in charge of the execution. The aggregated context may then be executed in the run-time environment 821 of the component by Agent3.

In another embodiment, the UE 107 and the component may exchange places and the distribution is performed from the component to UE 107. In another embodiment, the component may be a UE. In this embodiment the decomposition and aggregation processes are similar to the above example.

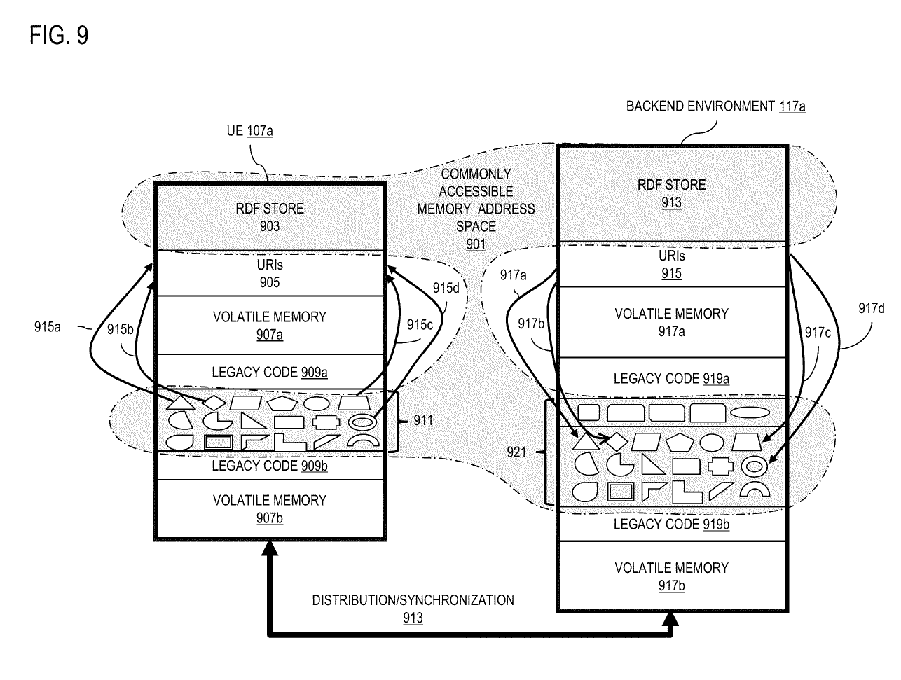

FIG. 9 is a diagram of computational allocation/mapping, according to one embodiment. The diagram of FIG. 9 shows a commonly accessible memory address space 901 formed between a UE 107a as a client and the backend environment 117.

In one embodiment, the UE 107a may include RDF store 903, which holds computational closures, functional blocks, or a combination thereof, for processes associated with the UE 107a. Similarly the backend environment 117 may includes a RDF store 913, which holds computational closures, functional blocks, or a combination thereof, associated with processes related to device 119a, UEs 107a-107i, or any other devices having connectivity to backend environment 117 or cloud 111.

In other embodiments, the Uniform Resource Identifiers (URIs) 905 in UE 107a and 915 in backend environment 117 may be used to identify names or resources accessible to their respective devices via the communication network 105. Furthermore, the legacy codes associated with each device may be stored in legacy code memory areas 909a and 909b on UE 107a and 919a and 919b on backend environment 117.

In one embodiment, UE 107a may be provided with a non-volatile memory space 911 as an information store. The information store 911 may include a set of closure primitives shown as geometric objects, similar to primitives of functional blocks 401 or 403 of FIG. 4. Similarly, the backend environment 117 may be provided with a non-volatile memory space 921 as an information store. The information store 921 may also include closure/block primitives shown as geometric objects. In one embodiment, the information store 911 is a subset of information store 921 determined, at least in part, based on one or more criteria such as time of access, frequency of access, a priority classification, etc. Since non-volatile memories are costly and require extensive resources (e.g. Power consumption) compared with volatile memories (such as 907a, 907b, 917a, and 917b), the capacity of non-volatile memory on a UE 107a-107i is limited. However, a backend environment 117, serving high numbers of users, may be equipped with larger volumes of non-volatile memory spaces. Because of the limited capacity of non-volatile memory spaces on UEs 107a-107i, a subset of the information store 921 is stored locally at the information store 911 for local use by the UE 107a. In order to minimize the number of times UE 107a needs to retrieve one or more primitives from information store 921 of backend environment 117, the subset 911 is determined based on one or more criteria. In one embodiment, the information store 911 may be determined as a set of the most frequently accessed primitives of information store 921 by UE 107a. In another embodiment, the information store 911 may be determined as a set of the most recently accessed primitives of information store 921 by UE 107a. In other embodiments, various combined conditions and criteria may be used for determining subset 911 from set 921 as the content of information store for UE 107a. Furthermore, the information stores 911 and 921 may be periodically synchronized. The synchronization of information stores ensures that any changes (addition, deletion, modification, etc.) in closure primitives of information store 921 are reflected in the information store 911.

In one embodiment, for execution of a functional block (a subset of information store 911) associated with a process on UE 107a, the block can be provided by the computational flow execution platform 103 to the backend environment 117 (the distribution/synchronization path shown as arrow 923). The computational flow execution platform 103 may then inform the processing components of the UE 107a, the backend environment 117 or a combination thereof (the processing components are not shown), that the primitives are ready for execution.

In one embodiment, any changes on the information store 921 of the backend device 119a (e.g., addition, deletion, modification, etc.) may first enter the URIs 915 via the communication network 105. The changes may then be applied from URIs 915 on information store 921 shown by arrows 927a-927d. Similarly, the information store 911 is updated based on the content of the information store 921 and the updates are shared with other components within UE 107a (e.g., with URIs 905 as shown by arrows 925a-925d).

In one embodiment, the commonly accessible memory address space 901 is formed from the RDF stores 903 and 913 and the information stores 911 and 921. The commonly accessible memory address space 901 can be accessed as a continuous memory space by each of the device 107a and backend environment 117.

The processes described herein for computational flow execution utilizing functional blocks may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

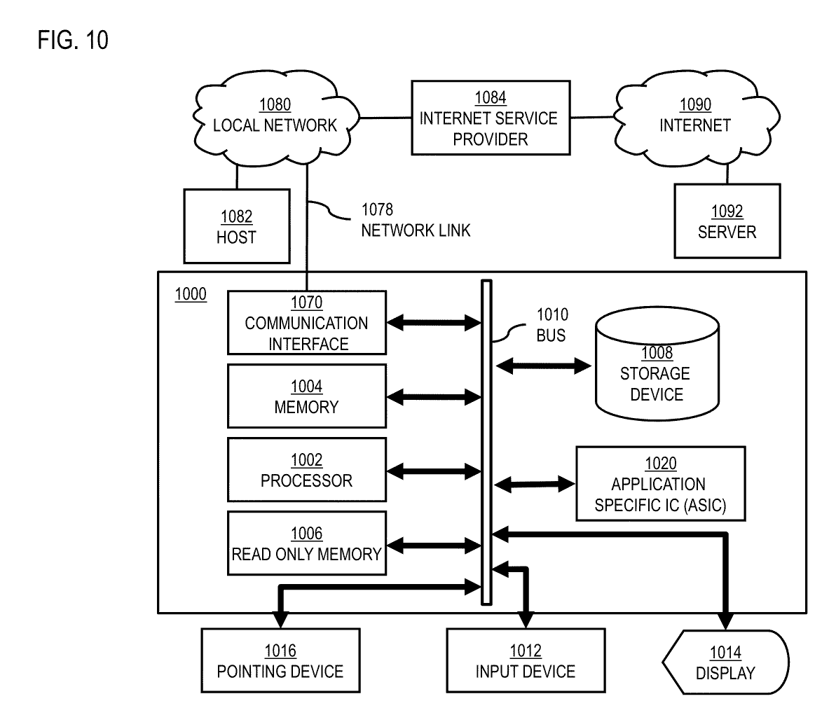

FIG. 10 illustrates a computer system 1000 upon which an embodiment of the invention may be implemented. Although computer system 1000 is depicted with respect to a particular device or equipment, it is contemplated that other devices or equipment (e.g., network elements, servers, etc.) within FIG. 10 can deploy the illustrated hardware and components of system 1000. Computer system 1000 is programmed (e.g., via computer program code or instructions) to execute a computational flow as described herein and includes a communication mechanism such as a bus 1010 for passing information between other internal and external components of the computer system 1000. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1000, or a portion thereof, constitutes a means for performing one or more steps of computational flow execution.

A bus 1010 includes one or more parallel conductors of information so that information is transferred quickly among devices coupled to the bus 1010. One or more processors 1002 for processing information are coupled with the bus 1010.

A processor (or multiple processors) 1002 performs a set of operations on information as specified by computer program code related to execute a computational flow. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1010 and placing information on the bus 1010. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1002, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1000 also includes a memory 1004 coupled to bus 1010. The memory 1004, such as a random access memory (RAM) or any other dynamic storage device, stores information including processor instructions for computational flow execution. Dynamic memory allows information stored therein to be changed by the computer system 1000. RAM allows a unit of information stored at a location called a memory address to be stored and retrieved independently of information at neighboring addresses. The memory 1004 is also used by the processor 1002 to store temporary values during execution of processor instructions. The computer system 1000 also includes a read only memory (ROM) 1006 or any other static storage device coupled to the bus 1010 for storing static information, including instructions, that is not changed by the computer system 1000. Some memory is composed of volatile storage that loses the information stored thereon when power is lost. Also coupled to bus 1010 is a non-volatile (persistent) storage device 1008, such as a magnetic disk, optical disk or flash card, for storing information, including instructions, that persists even when the computer system 1000 is turned off or otherwise loses power.

Information, including instructions for computational flow execution, is provided to the bus 1010 for use by the processor from an external input device 1012, such as a keyboard containing alphanumeric keys operated by a human user, or a sensor. A sensor detects conditions in its vicinity and transforms those detections into physical expression compatible with the measurable phenomenon used to represent information in computer system 1000. Other external devices coupled to bus 1010, used primarily for interacting with humans, include a display device 1014, such as a cathode ray tube (CRT), a liquid crystal display (LCD), a light emitting diode (LED) display, an organic LED (OLED) display, a plasma screen, or a printer for presenting text or images, and a pointing device 1016, such as a mouse, a trackball, cursor direction keys, or a motion sensor, for controlling a position of a small cursor image presented on the display 1014 and issuing commands associated with graphical elements presented on the display 1014. In some embodiments, for example, in embodiments in which the computer system 1000 performs all functions automatically without human input, one or more of external input device 1012, display device 1014 and pointing device 1016 is omitted.

In the illustrated embodiment, special purpose hardware, such as an application specific integrated circuit (ASIC) 1020, is coupled to bus 1010. The special purpose hardware is configured to perform operations not performed by processor 1002 quickly enough for special purposes. Examples of ASICs include graphics accelerator cards for generating images for display 1014, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1000 also includes one or more instances of a communications interface 1070 coupled to bus 1010. Communication interface 1070 provides a one-way or two-way communication coupling to a variety of external devices that operate with their own processors, such as printers, scanners and external disks. In general the coupling is with a network link 1078 that is connected to a local network 1080 to which a variety of external devices with their own processors are connected. For example, communication interface 1070 may be a parallel port or a serial port or a universal serial bus (USB) port on a personal computer. In some embodiments, communications interface 1070 is an integrated services digital network (ISDN) card or a digital subscriber line (DSL) card or a telephone modem that provides an information communication connection to a corresponding type of telephone line. In some embodiments, a communication interface 1070 is a cable modem that converts signals on bus 1010 into signals for a communication connection over a coaxial cable or into optical signals for a communication connection over a fiber optic cable. As another example, communications interface 1070 may be a local area network (LAN) card to provide a data communication connection to a compatible LAN, such as Ethernet. Wireless links may also be implemented. For wireless links, the communications interface 1070 sends or receives or both sends and receives electrical, acoustic or electromagnetic signals, including infrared and optical signals, that carry information streams, such as digital data. For example, in wireless handheld devices, such as mobile telephones like cell phones, the communications interface 1070 includes a radio band electromagnetic transmitter and receiver called a radio transceiver. In certain embodiments, the communications interface 1070 enables connection between the UE 101 and the communication network 105 for computational flow execution.

The term “computer-readable medium” as used herein refers to any medium that participates in providing information to processor 1002, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 1008. Volatile media include, for example, dynamic memory 1004. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1020.

Network link 1078 typically provides information communication using transmission media through one or more networks to other devices that use or process the information. For example, network link 1078 may provide a connection through local network 1080 to a host computer 1082 or to equipment 1084 operated by an Internet Service Provider (ISP). ISP equipment 1084 in turn provides data communication services through the public, world-wide packet-switching communication network of networks now commonly referred to as the Internet 1090.

A computer called a server host 1092 connected to the Internet hosts a process that provides a service in response to information received over the Internet. For example, server host 1092 hosts a process that provides information representing video data for presentation at display 1014. It is contemplated that the components of system 1000 can be deployed in various configurations within other computer systems, e.g., host 1082 and server 1092.

At least some embodiments of the invention are related to the use of computer system 1000 for implementing some or all of the techniques described herein. According to one embodiment of the invention, those techniques are performed by computer system 1000 in response to processor 1002 executing one or more sequences of one or more processor instructions contained in memory 1004. Such instructions, also called computer instructions, software and program code, may be read into memory 1004 from another computer-readable medium such as storage device 1008 or network link 1078. Execution of the sequences of instructions contained in memory 1004 causes processor 1002 to perform one or more of the method steps described herein. In alternative embodiments, hardware, such as ASIC 1020, may be used in place of or in combination with software to implement the invention. Thus, embodiments of the invention are not limited to any specific combination of hardware and software, unless otherwise explicitly stated herein.

The signals transmitted over network link 1078 and other networks through communications interface 1070, carry information to and from computer system 1000. Computer system 1000 can send and receive information, including program code, through the networks 1080, 1090 among others, through network link 1078 and communications interface 1070. In an example using the Internet 1090, a server host 1092 transmits program code for a particular application, requested by a message sent from computer 1000, through Internet 1090, ISP equipment 1084, local network 1080 and communications interface 1070. The received code may be executed by processor 1002 as it is received, or may be stored in memory 1004 or in storage device 1008 or any other non-volatile storage for later execution, or both. In this manner, computer system 1000 may obtain application program code in the form of signals on a carrier wave.

Various forms of computer readable media may be involved in carrying one or more sequence of instructions or data or both to processor 1002 for execution. For example, instructions and data may initially be carried on a magnetic disk of a remote computer such as host 1082. The remote computer loads the instructions and data into its dynamic memory and sends the instructions and data over a telephone line using a modem. A modem local to the computer system 1000 receives the instructions and data on a telephone line and uses an infra-red transmitter to convert the instructions and data to a signal on an infra-red carrier wave serving as the network link 1078. An infrared detector serving as communications interface 1070 receives the instructions and data carried in the infrared signal and places information representing the instructions and data onto bus 1010. Bus 1010 carries the information to memory 1004 from which processor 1002 retrieves and executes the instructions using some of the data sent with the instructions. The instructions and data received in memory 1004 may optionally be stored on storage device 1008, either before or after execution by the processor 1002.

FIG. 11 illustrates a chip set or chip 1100 upon which an embodiment of the invention may be implemented. Chip set 1100 is programmed to execute a computational flow as described herein and includes, for instance, the processor and memory components described with respect to FIG. 10 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1100 can be implemented in a single chip. It is further contemplated that in certain embodiments the chip set or chip 1100 can be implemented as a single “system on a chip.” It is further contemplated that in certain embodiments a separate ASIC would not be used, for example, and that all relevant functions as disclosed herein would be performed by a processor or processors. Chip set or chip 1100, or a portion thereof, constitutes a means for performing one or more steps of providing user interface navigation information associated with the availability of functions. Chip set or chip 1100, or a portion thereof, constitutes a means for performing one or more steps of computational flow execution.

In one embodiment, the chip set or chip 1100 includes a communication mechanism such as a bus 1101 for passing information among the components of the chip set 1100. A processor 1103 has connectivity to the bus 1101 to execute instructions and process information stored in, for example, a memory 1105. The processor 1103 may include one or more processing cores with each core configured to perform independently. A multi-core processor enables multiprocessing within a single physical package. Examples of a multi-core processor include two, four, eight, or greater numbers of processing cores. Alternatively or in addition, the processor 1103 may include one or more microprocessors configured in tandem via the bus 1101 to enable independent execution of instructions, pipelining, and multithreading. The processor 1103 may also be accompanied with one or more specialized components to perform certain processing functions and tasks such as one or more digital signal processors (DSP) 1107, or one or more application-specific integrated circuits (ASIC) 1109. A DSP 1107 typically is configured to process real-world signals (e.g., sound) in real time independently of the processor 1103. Similarly, an ASIC 1109 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 1100 includes merely one or more processors and some software and/or firmware supporting and/or relating to and/or for the one or more processors.

The processor 1103 and accompanying components have connectivity to the memory 1105 via the bus 1101. The memory 1105 includes both dynamic memory (e.g., RAM, magnetic disk, writable optical disk, etc.) and static memory (e.g., ROM, CD-ROM, etc.) for storing executable instructions that when executed perform the inventive steps described herein to execute a computational flow. The memory 1105 also stores the data associated with or generated by the execution of the inventive steps.

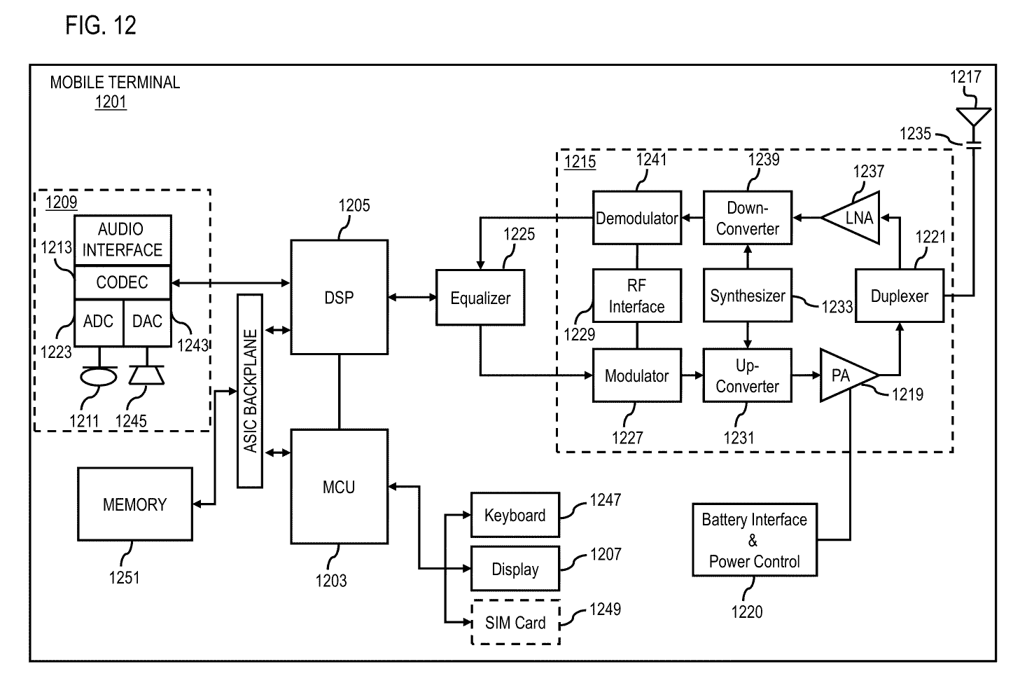

FIG. 12 is a diagram of exemplary components of a mobile terminal (e.g., handset) for communications, which is capable of operating in the system of FIG. 1, according to one embodiment. In some embodiments, mobile terminal 1201, or a portion thereof, constitutes a means for performing one or more steps of computational flow execution. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1203, a Digital Signal Processor (DSP) 1205, and a receiver/transmitter unit including a microphone gain control unit and a speaker gain control unit. A main display unit 1207 provides a display to the user in support of various applications and mobile terminal functions that perform or support the steps of computational flow execution. The display 1207 includes display circuitry configured to display at least a portion of a user interface of the mobile terminal (e.g., mobile telephone). Additionally, the display 1207 and display circuitry are configured to facilitate user control of at least some functions of the mobile terminal. An audio function circuitry 1209 includes a microphone 1211 and microphone amplifier that amplifies the speech signal output from the microphone 1211. The amplified speech signal output from the microphone 1211 is fed to a coder/decoder (CODEC) 1213.

A radio section 1215 amplifies power and converts frequency in order to communicate with a base station, which is included in a mobile communication system, via antenna 1217. The power amplifier (PA) 1219 and the transmitter/modulation circuitry are operationally responsive to the MCU 1203, with an output from the PA 1219 coupled to the duplexer 1221 or circulator or antenna switch, as known in the art. The PA 1219 also couples to a battery interface and power control unit 1220.

In use, a user of mobile terminal 1201 speaks into the microphone 1211 and his or her voice along with any detected background noise is converted into an analog voltage. The analog voltage is then converted into a digital signal through the Analog to Digital Converter (ADC) 1223. The control unit 1203 routes the digital signal into the DSP 1205 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1225 for compensation of any frequency-dependent impairments that occur during transmission though the air such as phase and amplitude distortion. After equalizing the bit stream, the modulator 1227 combines the signal with a RF signal generated in the RF interface 1229. The modulator 1227 generates a sine wave by way of frequency or phase modulation. In order to prepare the signal for transmission, an up-converter 1231 combines the sine wave output from the modulator 1227 with another sine wave generated by a synthesizer 1233 to achieve the desired frequency of transmission. The signal is then sent through a PA 1219 to increase the signal to an appropriate power level. In practical systems, the PA 1219 acts as a variable gain amplifier whose gain is controlled by the DSP 1205 from information received from a network base station. The signal is then filtered within the duplexer 1221 and optionally sent to an antenna coupler 1235 to match impedances to provide maximum power transfer. Finally, the signal is transmitted via antenna 1217 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1201 are received via antenna 1217 and immediately amplified by a low noise amplifier (LNA) 1237. A down-converter 1239 lowers the carrier frequency while the demodulator 1241 strips away the RF leaving only a digital bit stream. The signal then goes through the equalizer 1225 and is processed by the DSP 1205. A Digital to Analog Converter (DAC) 1243 converts the signal and the resulting output is transmitted to the user through the speaker 1245, all under control of a Main Control Unit (MCU) 1203 which can be implemented as a Central Processing Unit (CPU) (not shown).

The MCU 1203 receives various signals including input signals from the keyboard 1247. The keyboard 1247 and/or the MCU 1203 in combination with other user input components (e.g., the microphone 1211) comprise a user interface circuitry for managing user input. The MCU 1203 runs a user interface software to facilitate user control of at least some functions of the mobile terminal 1201 to execute a computational flow. The MCU 1203 also delivers a display command and a switch command to the display 1207 and to the speech output switching controller, respectively. Further, the MCU 1203 exchanges information with the DSP 1205 and can access an optionally incorporated SIM card 1249 and a memory 1251. In addition, the MCU 1203 executes various control functions required of the terminal. The DSP 1205 may, depending upon the implementation, perform any of a variety of conventional digital processing functions on the voice signals. Additionally, DSP 1205 determines the background noise level of the local environment from the signals detected by microphone 1211 and sets the gain of microphone 1211 to a level selected to compensate for the natural tendency of the user of the mobile terminal 1201.

The CODEC 1213 includes the ADC 1223 and DAC 1243. The memory 1251 stores various data including call incoming tone data and is capable of storing other data including music data received via, e.g., the global Internet. The software module could reside in RAM memory, flash memory, registers, or any other form of writable storage medium known in the art. The memory device 1251 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1249 carries, for instance, important information, such as the cellular phone number, the carrier supplying service, subscription details, and security information. The SIM card 1249 serves primarily to identify the mobile terminal 1201 on a radio network. The card 1249 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
a construction of at least one computational flow from one or more functional blocks, wherein the one or more functional blocks include, at least in part, one or more computational closures, one or more other functional blocks, or a combination thereof;
a processing of the at least one computational flow, the one or more functional blocks, or a combination thereof to cause, at least in part, a distribution of the one or more functional blocks among one or more entities of a computational environment; and
an execution of the at least one computational flow, the one or more functional blocks, or a combination thereof based, at least in part, on the distribution.

2. A method of claim 1, wherein the (1) data and/or (2) information and/or (3) at least one signal are further based, at least in part, on the following:
one or more ontologies associated with the at least one computational flow, the one or more functional blocks, or a combination thereof,
wherein the distribution is based, at least in part, on the one or more ontologies.

3. A method of claim 2, wherein the (1) data and/or (2) information and/or (3) at least one signal are further based, at least in part, on the following:
one or more connectors, one or more functions, one or more interfaces, or a combination thereof associated with the one or more functional blocks;
a processing of the one or more ontologies to determine one or more semantic descriptions of the one or more connectors, the one or more functions, the one or more interfaces, or a combination thereof,
wherein the execution, the distribution, or a combination thereof are based, at least in part, on the one or more semantic descriptions.

4. A method of claim 3, wherein the one or more connectors, the one or more functions, the one or more interfaces, or a combination thereof are specified with respect to one or more inputs, one or more outputs, or a combination thereof of the at least one computational flow, the one or more functional blocks, or a combination thereof.

5. A method of claim 3, wherein the (1) data and/or (2) information and/or (3) at least one signal are further based, at least in part, on the following:
a processing of the one or more semantic descriptions to cause, at least in part, the execution, the distribution, or a combination thereof to be performed in parallel among the one or more entities.

6. A method of claim 1, wherein the (1) data and/or (2) information and/or (3) at least one signal are further based, at least in part, on the following:
one or more cost functions associated with the at least one computational flow, the one or more functional blocks, or a combination thereof,
wherein the execution, the distribution, or a combination thereof are based, at least in part, on the one or more cost functions.

7. A method of claim 6, wherein the one or more cost functions relate, at least in part, to one or more resources, one or privacy policies, one or more security policies, or a combination associated with the one or more entities.

8. A method of claim 7, wherein the at least one computational flow, the one or more functional blocks, or a combination thereof are represented, at least in part, in at least one data structure of at least one information space, at least one information store, at least one cloud computing component, or a combination thereof, and wherein the one or more costs functions are associated with the at least one data structure.

9. A method of claim 8, wherein the (1) data and/or (2) information and/or (3) at least one signal are further based, at least in part, on the following:
an exchange of the at least one data structure via a publish/subscribe mechanism.

10. A method of claim 8, wherein the at least one data structure is based, at least in part, on a resource description framework, and wherein the (1) data and/or (2) information and/or (3) at least one signal are further based, at least in part, on the following:
a serialization of one or more resource description graphs associated with the at least one computational flow, the one or more functional blocks, or a combination thereof,
wherein the execution, the distribution, or a combination thereof is based, at least in part, on the serialization.

11. An apparatus comprising:
at least one processor; and
at least one memory including computer program code for one or more programs,
the at least one memory and the computer program code configured to, with the at least one processor, cause the apparatus to perform at least the following,
determine to cause, at least in part, a construction of at least one computational flow from one or more functional blocks, wherein the one or more functional blocks include, at least in part, one or more computational closures, one or more other functional blocks, or a combination thereof;
process and/or facilitate a processing of the at least one computational flow, the one or more functional blocks, or a combination thereof to cause, at least in part, a distribution of the one or more functional blocks among one or more entities of a computational environment; and
cause, at least in part, an execution of the at least one computational flow, the one or more functional blocks, or a combination thereof based, at least in part, on the distribution.

12. An apparatus of claim 11, wherein the apparatus is further caused to:
determine one or more ontologies associated with the at least one computational flow, the one or more functional blocks, or a combination thereof,
wherein the distribution is based, at least in part, on the one or more ontologies.

13. An apparatus of claim 12, wherein the apparatus is further caused to:
determine one or more connectors, one or more functions, one or more interfaces, or a combination thereof associated with the one or more functional blocks;
process and/or facilitate a processing of the one or more ontologies to determine one or more semantic descriptions of the one or more connectors, the one or more functions, the one or more interfaces, or a combination thereof,
wherein the execution, the distribution, or a combination thereof are based, at least in part, on the one or more semantic descriptions.

14. An apparatus of claim 13, wherein the one or more connectors, the one or more functions, the one or more interfaces, or a combination thereof are specified with respect to one or more inputs, one or more outputs, or a combination thereof of the at least one computational flow, the one or more functional blocks, or a combination thereof.

15. An apparatus of claim 13, wherein the apparatus is further caused to:
process and/or facilitate a processing of the one or more semantic descriptions to cause, at least in part, the execution, the distribution, or a combination thereof to be performed in parallel among the one or more entities.

16. An apparatus of claim 11, wherein the apparatus is further caused to:
determine one or more cost functions associated with the at least one computational flow, the one or more functional blocks, or a combination thereof,
wherein the execution, the distribution, or a combination thereof are based, at least in part, on the one or more cost functions.

17. An apparatus of claim 16, wherein the one or more cost functions relate, at least in part, to one or more resources, one or privacy policies, one or more security policies, or a combination associated with the one or more entities.

18. An apparatus of claim 17, wherein the at least one computational flow, the one or more functional blocks, or a combination thereof are represented, at least in part, in at least one data structure of at least one information space, at least one information store, at least one cloud computing component, or a combination thereof, and wherein the one or more costs functions are associated with the at least one data structure.

19. An apparatus of claim 18, wherein the apparatus is further caused to:
cause, at least in part, an exchange of the at least one data structure via a publish/subscribe mechanism.

20. An apparatus of claim 18, wherein the at least one data structure is based, at least in part, on a resource description framework, the method further comprising:
cause, at least in part, a serialization of one or more resource description graphs associated with the at least one computational flow, the one or more functional blocks, or a combination thereof,
wherein the execution, the distribution, or a combination thereof is based, at least in part, on the serialization.

21.-48. (canceled)
